(19) United States
(12) Patent Application Publication
(10) Pub. No.: US 2009/0040443 A1
(43) Pub. Date: Feb. 12, 2009

(54) METHOD OF PRODUCING A LIQUID CRYSTAL PANEL, LIQUID CRYSTAL PANEL, AND IMAGE DISPLAY APPARATUS

(75) Inventors: Kazuya Hada, Ibaraki-shi (JP); Ikuo Kawamoto, Ibaraki-shi (JP); Takashi Kamijou, Ibaraki-shi (JP); Hideyuki Yonezawa, Ibaraki-shi (JP); Seiji Umemoto, Ibaraki-shi (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi, Osaka (JP)

(21) Appl. No.: 11/573,594

(22) PCT Filed: Aug. 2, 2006
(86) PCT No.: PCT/JP2006/315286

§ 371 Date: Feb. 12, 2007

(30) Foreign Application Priority Data
Nov. 25, 2005 (JP) 2005-339644

(51) Int. Cl. G02F 1/13363

(52) U.S. Cl. 349/118; 349/187

(57) ABSTRACT

To provide a method of producing a liquid crystal panel capable of easily realizing stable high contrast of the liquid crystal panel to be obtained at low cost, a liquid crystal panel, and an image display apparatus. There is provided a method of producing a liquid crystal panel including a first optical compensation layer having refractive index profile of nx>ny=nz and a polarizer on each side of a liquid crystal cell in the order given, in which an angle formed between an absorption axis of the polarizer (A) and a slow axis of the first optical compensation layer (B) on one side of the liquid crystal cell is +α°, an angle formed between an absorption axis of the polarizer (A′) and a slow axis of the first compensation layer (B′) on another side of the liquid crystal cell is −α°, and 0<α<90, the method comprises a step of subjecting substrate formed of single original sheet to alignment treatment at +α° and alignment treatment at −α° with respect to a longitudinal direction of the substrate; and a step of forming the first optical compensation layer (B) on the surface subjected to the +α° alignment treatment and forming the first optical compensation layer (B′) on the surface subjected to the −α° alignment treatment.

### TECHNICAL FIELD

The present invention relates to a method of producing a liquid crystal panel, to a liquid crystal panel, and to an image display apparatus. In particular, the present invention relates to a method of producing a liquid crystal panel capable of easily realizing stable high contrast of the liquid crystal panel at low cost, to a liquid crystal panel, and to an image display apparatus.

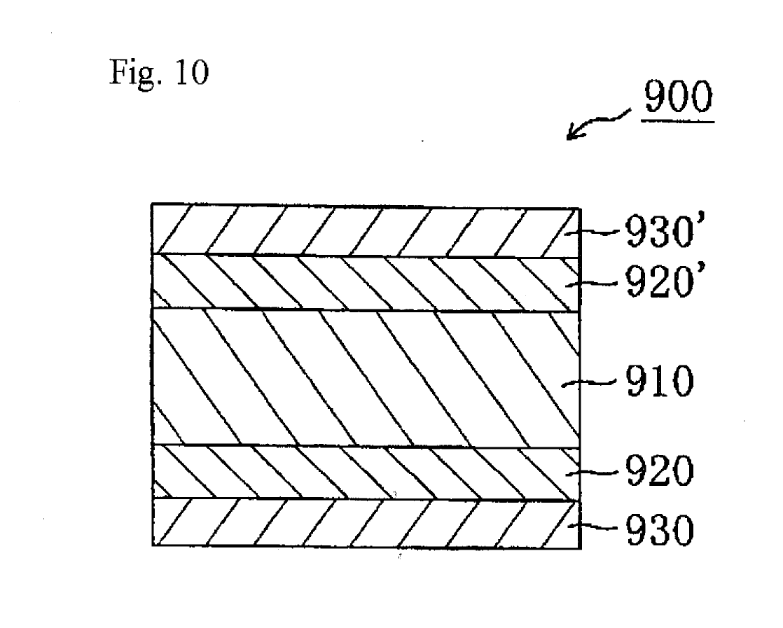

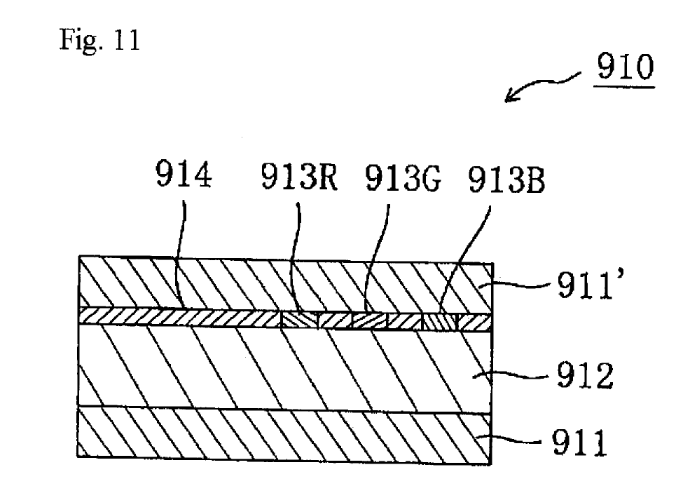

FIG. 10 is a schematic sectional view of a typical conventional liquid crystal panel, and FIG. 11 is a schematic sectional view of a typical liquid crystal cell to be used for the liquid crystal panel. A liquid crystal panel 900 is provided with: a liquid crystal cell 910; retardation plates 920 and 920′ arranged on outer sides of the liquid crystal cell 910; and polarizing plates 930 and 930′ arranged on outer sides of the respective retardation plates 920 and 920′. Typically, the polarizing plates 930 and 930′ are arranged such that respective polarization axes are perpendicular to each other. The liquid crystal cell 910 includes: a pair of substrates 911 and 911′; and a liquid crystal layer 912 as a display medium arranged between the substrates. One substrate 911 is provided with: a switching element (typically, TFT) for controlling electrooptic properties of liquid crystals; and a scanning line for providing a gate signal to this switching element and a signal line for providing a source signal thereto (the element and the lines not shown). The other substrate 911′ is provided with: color layers 913R, 913G, and 913B forming a color filter; and a screen layer (black matrix layer) 914. A distance (cell gap) between the substrates 911 and 911′ is controlled by a spacer (not shown).

The retardation plates are used for optical compensation of a liquid crystal display apparatus. In order to obtain optimum optical compensation (improvement in viewing angle properties, color shift, and contrast, for example), various attempts have been made in optimization of optical properties of the retardation plates and/or arrangement of the retardation plates in the liquid crystal display apparatus (see Patent Document 1, for example).

Two specific retardation plates are arranged on both sides of the liquid crystal cell in a specific positional relationship in which an angle formed between an absorption axis of a polarizer in the polarizing plate 930 provided on one side of the liquid crystal cell and a slow axis of the retardation plate 920 having refractive index profile of nx>ny=nz is +α° and an angle formed between an absorption axis of a polarizer in the polarizing plate 930′ provided on another side of the liquid crystal cell and a slow axis of the retardation plate 920′ having refractive index profile of nx>ny=nz is −α°, to thereby improve contrast of the liquid crystal panel. However, a conventional liquid crystal panel to be obtained by this method is not capable of realizing stable high contrast. Contrast may vary by production lot, and a low contrast product may be obtained depending on the production lot.

### Patent Document 1: JP 11-95208 A

### DISCLOSURE OF THE INVENTION

### Problem to be Solved by the Invention

The present invention has been made in view of solving the conventional problems described above, and an object of the present invention is therefore to provide a method of producing a liquid crystal panel capable of easily realizing stable high contrast of the liquid crystal panel to be obtained at low cost, a liquid crystal panel, and an image display apparatus.

### Means for Solving the Problem

The inventors of the present invention have focused on a production process for retardation plates to be arranged on both sides of a liquid crystal cell for attaining the object described above. Conventionally, a retardation film having an angle +α° and a retardation film having an angle −α° had been produced from separate original sheets. However, the inventors of the present invention have found that the above-mentioned object can be attained by producing the retardation plates from single original sheet, and thus have completed the present invention.

A method of producing a liquid crystal panel of the present invention includes a first optical compensation layer having refractive index profile of nx>ny=nz and a polarizer on each side of a liquid crystal cell in the order given, in which an angle formed between an absorption axis of the polarizer (A) and a slow axis of the first optical compensation layer (B) on one side of the liquid crystal cell is +α°, an angle formed between an absorption axis of the polarizer (A′) and a slow axis of the first compensation layer (B′) on another side of the liquid crystal cell is −α°, and 0<α<90, the method comprising the steps of:

subjecting a surface of a continuous substrate formed of single original sheet to alignment treatment at +α° or −α° with respect to a longitudinal direction of the substrate and then successively subjecting the resultant to alignment treatment at an angle of an opposite sign;

forming the first optical compensation layer (B) on the surface subjected to the +α° alignment treatment and forming the first optical compensation layer (B′) on the surface subjected to the −α° alignment treatment; and

attaching continuously a surface opposite to the surface of the substrate subjected to the alignment treatment and the continuous polarizer having an absorption axis in a longitudinal direction while arranging respective longitudinal directions in the same direction.

A method of producing a liquid crystal panel of the present invention includes a first optical compensation layer having refractive index profile of nx>ny=nz and a polarizer on each side of a liquid crystal cell in the order given, in which an angle formed between an absorption axis of the polarizer (A) and a slow axis of the first optical compensation layer (B) on one side of the liquid crystal cell is +α°, an angle formed between an absorption axis of the polarizer (A′) and a slow axis of the first compensation layer (B′) on another side of the liquid crystal cell is −α°, and 0<α<90, the method comprising the steps of:

subjecting a surface of a continuous substrate formed of single original sheet to alignment treatment at +α° or −α° with respect to a longitudinal direction of the substrate and then successively subjecting the resultant to alignment treatment at an angle of an opposite sign;

forming the first optical compensation layer (B) on the surface subjected to the +α° alignment treatment and forming the first optical compensation layer (B′) on the surface subjected to the −α° alignment treatment;

transferring the first optical compensation layers (B) and (B′) formed on the substrate to a surface of a transparent protective film and peeling the substrate; and

attaching continuously a surface opposite to the first optical compensation layers (B) and (B′) of the transparent protective film and the continuous polarizer having an absorption axis in a longitudinal direction while arranging respective longitudinal directions in the same direction.

According to a preferred embodiment of the invention, the substrate formed of single original sheet is formed of single original sheet having a total length of 500 to 10,000 m.

According to a preferred embodiment of the invention, the step of forming the first optical compensation layers (B) and (B′) includes: a step of applying an application liquid containing a liquid crystal material; and a step of aligning the applied liquid crystal material through treatment at a temperature where the liquid crystal material exhibits a liquid crystal phase.

According to a preferred embodiment of the invention, the first optical compensation layers (B) and (B′) are each formed by using an application liquid of the same lot.

According to a preferred embodiment of the invention, the liquid crystal material includes a polymerizable monomer and/or a crosslinking monomer, and the step of aligning the liquid crystal material further comprises a step of conducting polymerization treatment and/or crosslinking treatment.

According to a preferred embodiment of the invention, the polymerization treatment and/or the crosslinking treatment is conducted through at least one of heating, photoirradiation, and UV irradiation.

According to a preferred embodiment of the invention, the liquid crystal panel comprises a second optical compensation layer (C) having refractive index profile of nx>ny>nz between the liquid crystal cell and the first optical compensation layer (B), and a second optical compensation layer (C′) having reflective index profile of nx>ny>nz between the liquid crystal cell and the first optical compensation layer (B′).

According to a preferred embodiment of the invention, an angle formed between the absorption axis of the polarizer (A) and a slow axis of the second optical compensation layer (C) is +β°, an angle formed between the absorption axis of the polarizer (A′) and a slow axis of the second optical compensation layer (C′) is +β°, and the angle β is 85 to 95.

According to a preferred embodiment of the invention, the first optical compensation layers (B) and (B′) are each a λ/2 plate.

According to a preferred embodiment of the invention, the second optical compensation layers (C) and (C′) are each α/4 plate.

Another aspect of the present invention provides a liquid crystal panel. The liquid crystal panel is produced by the production method of the present invention.

Still another aspect of the present invention provides an image display apparatus. The image display apparatus includes the liquid crystal panel of the present invention.

### EFFECT OF THE INVENTION

As described above, the present invention employs a production method for obtaining a first optical compensation layer (B) having an angle formed between its slow axis and an absorption axis of a polarizer of +α° and a first optical compensation layer (B) having an angle formed between its slow axis and an absorption axis of a polarizer of −α° comprising: a step of subjecting a surface of a continuous substrate formed of single original sheet to alignment treatment at +α° and alignment treatment at −α° with respect to a longitudinal direction of the substrate; and a step of forming the first optical compensation layer (B) on the surface subjected to the +α° alignment treatment and forming the first optical compensation layer (B′) on the surface subjected to the −α° alignment treatment. Thus, shift in in-plane retardation of the first optical compensation layer (B) and the first optical compensation layer (B′) to be arranged on both sides of the liquid crystal cell can be stably and significantly reduced. Therefore, high contrast can easily be realized for a liquid crystal panel and a liquid crystal display apparatus including the liquid crystal panel at low cost.

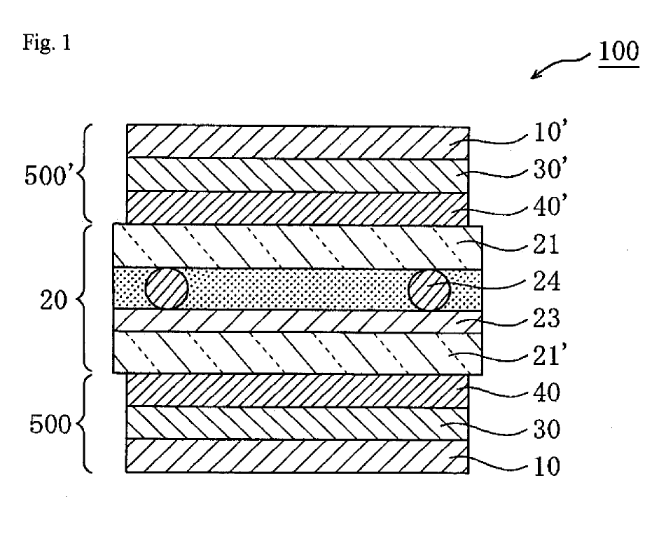

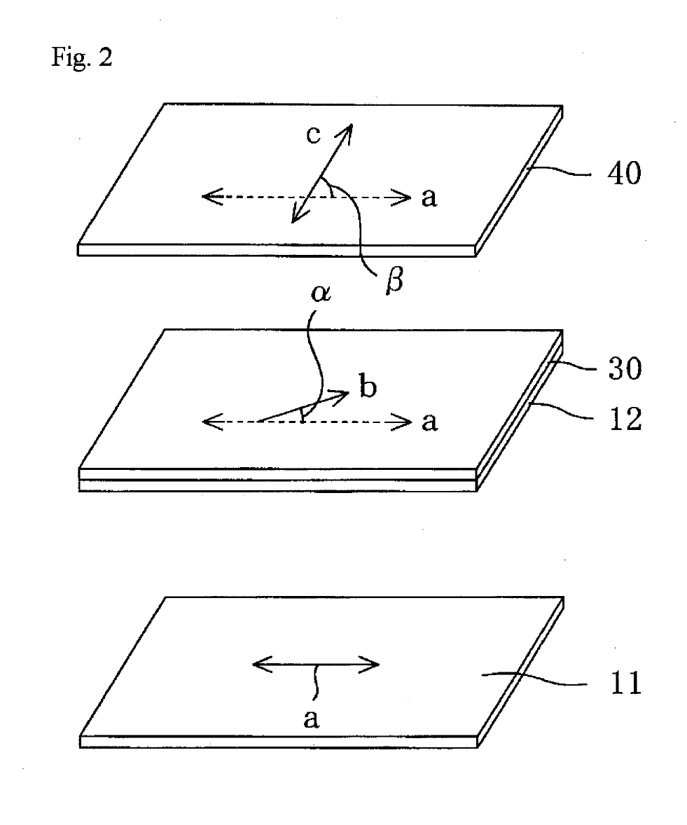

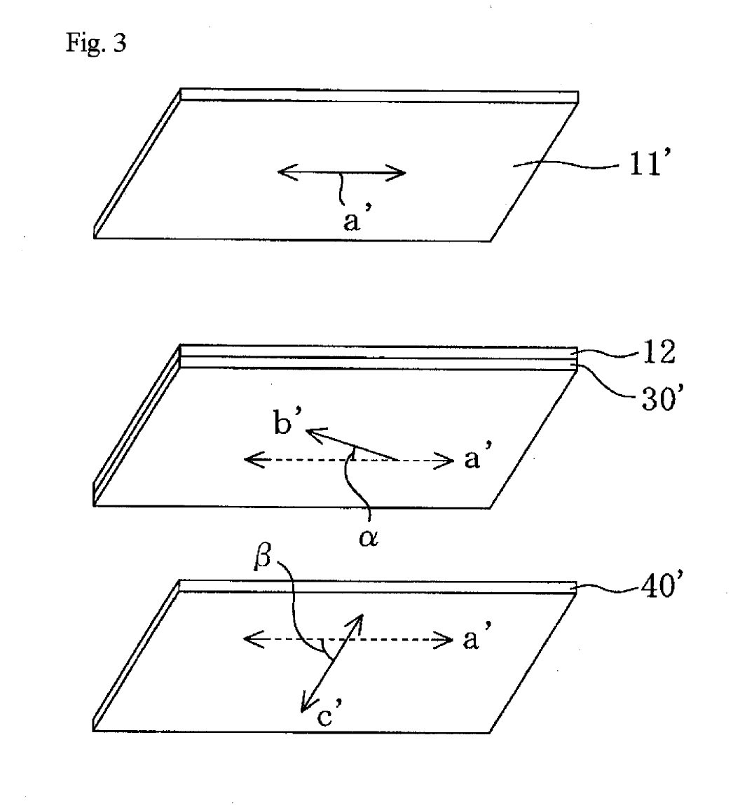

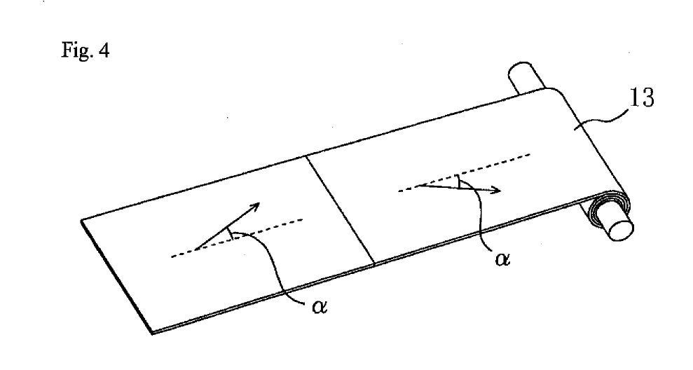

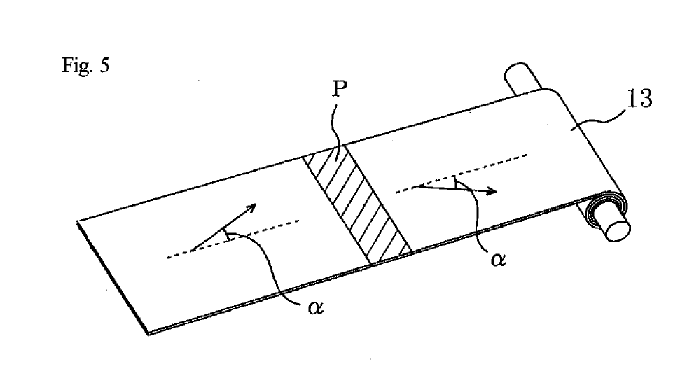

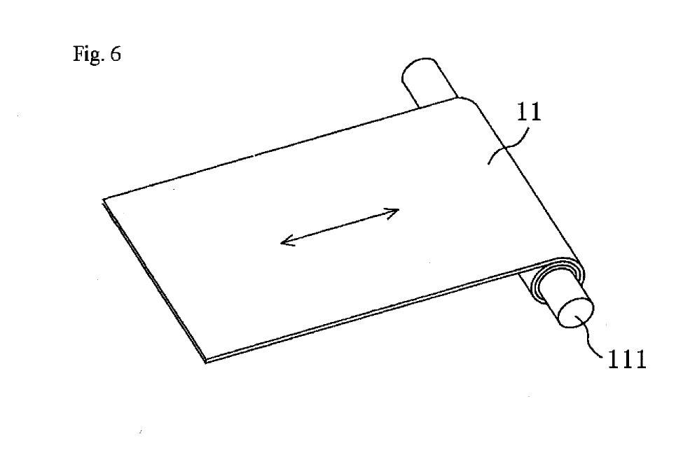

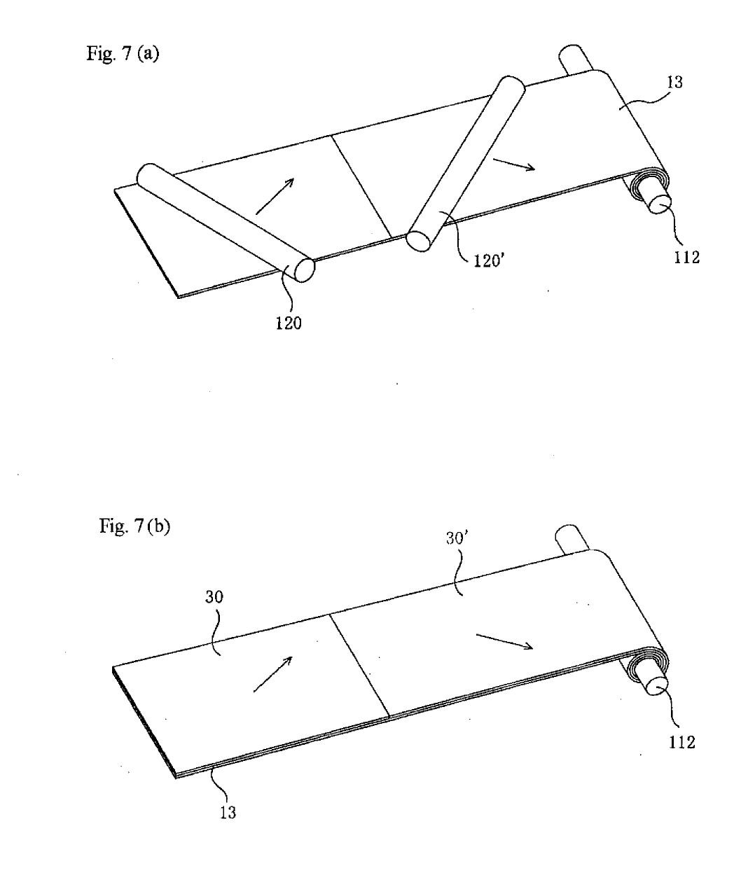

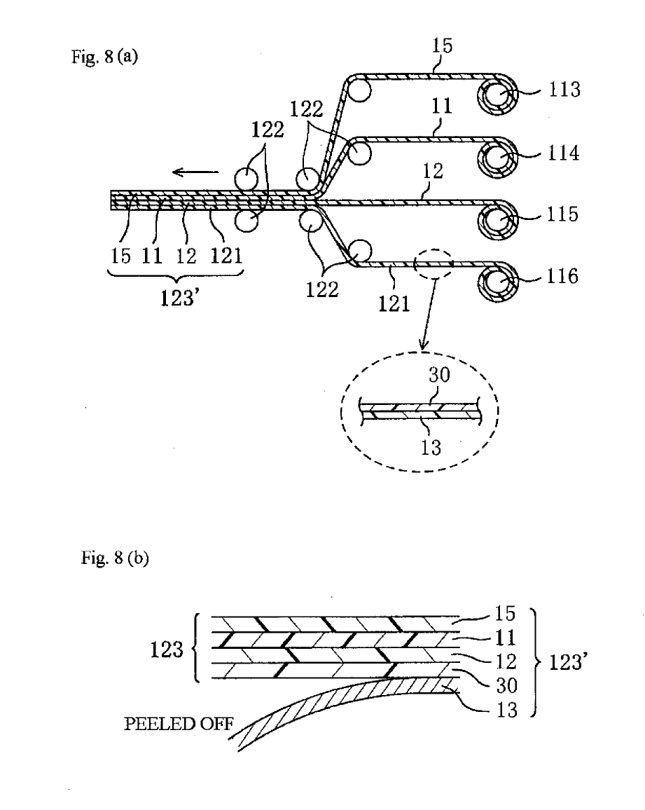

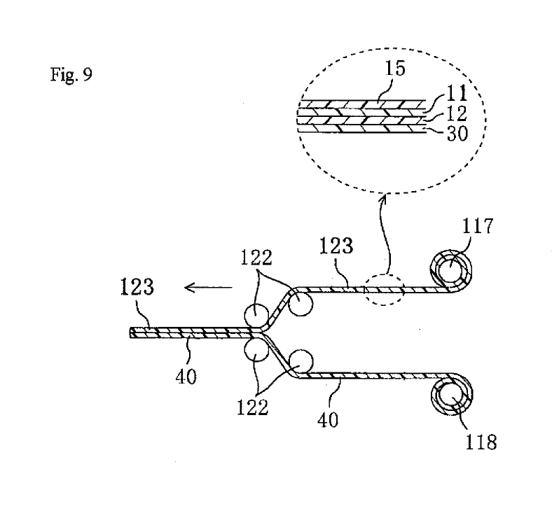

### BRIEF DESCRIPTION OF THE DRAWINGS

[FIG. 1] A schematic sectional view of a liquid crystal panel according to a preferred embodiment of the present invention.

[FIG. 2] An exploded perspective view of a polarizing plate provided with an optical compensation layer according to a preferred embodiment of the present invention.

[FIG. 3] An exploded perspective view of a polarizing plate provided with an optical compensation layer according to another preferred embodiment of the present invention.

[FIG. 4] A perspective view showing an example of alignment treatment in the present invention.

[FIG. 5] A perspective view showing another example of the alignment treatment in the present invention.

[FIG. 6] A perspective view showing a process outline according to an example of a method of producing a liquid crystal panel of the present invention.

[FIG. 7] Perspective views showing a process outline according to another example of the method of producing a liquid crystal panel of the present invention.

[FIG. 8] Perspective views showing a process outline according to still another example of the method of producing a liquid crystal panel of the present invention.

[FIG. 9] A perspective view showing a process outline according to still another example of the method of producing a liquid crystal panel of the present invention.

[FIG. 10] A schematic sectional view of a typical conventional liquid crystal panel.

[FIG. 11] A schematic sectional view of a typical liquid crystal cell to be used for a typical conventional liquid crystal panel.

### DESCRIPTION OF SYMBOLS

10, 10′ polarizing plate
11, 11′ polarizer
12 protective film
13 substrate
15 protective film
20 liquid crystal cell
30, 30′ first optical compensation layer
40, 40′ second optical compensation layer
100 liquid crystal panel
500, 500′ polarizing plate provided with optical compensation layer

### DESCRIPTION OF THE PREFERRED EMBODIMENTS

### Definitions of Terms and Symbols

Definitions of terms and symbols in the specification of the present invention are described below.

(1) The symbol “nx” refers to a refractive index in a direction providing a maximum in-plane refractive index (that is, a slow axis direction), and the symbol “ny” refers to a refractive index in a direction perpendicular to the slow axis in the same plane (that is, a fast axis direction). The symbol “nz” refers to a refractive index in a thickness direction. Further, the expression “nx=ny”, for example, not only refers to a case where nx and ny are exactly equal but also includes a case where nx and ny are substantially equal. In the specification of the present invention, the phrase “substantially equal” includes a case where nx and ny differ within a range providing no effects on overall optical characteristics of an optical film in practical use.

(2) The term “in-plane retardation Re” refers to an in-plane retardation value of a film (layer) measured at 23° C. by using light of a wavelength of 590 nm. Re can be determined from an equation Re=(nx−ny)×d, where nx and ny represent refractive indices of a film (layer) at a wavelength of 590 nm in a slow axis direction and a fast axis direction, respectively, and d (nm) represents a thickness of the film (layer).

(3) The term “thickness direction retardation Rth” refers to a thickness direction retardation value measured at 23° C. by using light of a wave length of 590 nm. Rth can be determined from an equation Rth=(nx−nz)×d, where nx and nz represent refractive indices of a film (layer) at a wavelength of 590 nm in a slow axis direction and a thickness direction, respectively, and d (nm) represents a thickness of the film (layer).

(4) An Nz coefficient refers to a ratio of in-plane retardation Re and thickness direction retardation Rth and is determined by an expression Nz=(nx−nz)/(nx−ny).

(5) The subscript “1” attached to a term or symbol described in the specification of the present invention represents a first optical compensation layer. The subscript “2” attached to a term or symbol described in the specification of the present invention represents a second optical compensation layer.

(6) The term “λ/2 plate” refers to a plate having a function of converting linearly polarized light having a specific vibration direction into linearly polarized light having a vibration direction perpendicular thereto, or converting right-handed circularly polarized light into left-handed circularly polarized light (or converting left-handed circularly polarized light into right-handed circularly polarized light). The λ/2 plate has an in-plane retardation value of a film (layer) of about ½ of a light wavelength (generally, in a visible light region).

(7) The term “λ/4” plates refers to a plate having a function of converting linearly polarized light of a specific wavelength into circularly polarized light (or converting circularly polarized light into linearly polarized light). The λ/4 plate has an in-plane retardation value of a film (layer) of about ¼ of a light wavelength (generally, in a visible light region).

(8) In the present invention, a case simply employing the term “first optical compensation layer” includes both first optical compensation layer (B) and first optical compensation layer (B′). Similarly, a case simply employing the term “second optical compensation layer” includes both second optical compensation layer (C) and second optical compensation layer (C′). A case employing the term “polarizer” includes both polarizer (A) and polarizer (A′).

(9) In the present invention, alignment treatment at +α° with respect to a substrate refers to alignment treatment by +α° in a counterclockwise direction with respect to a direction of the substrate seen from a direction at which a liquid crystal cell may eventually be arranged (a direction at which a pressure-sensitive adhesive layer may be formed), and alignment treatment at −α° with respect to a substrate refers to alignment treatment by −α° in a clockwise direction with respect to a direction of the substrate seen from a direction at which a liquid crystal cell may finally be arranged (a direction at which a pressure-sensitive adhesive layer may be formed).

(10) In the present invention, the term “single original sheet” refers to one seamless original sheet.

### A. Liquid Crystal Panel

### A-1. Overview of Liquid Crystal Panel

FIG. 1 is a schematic sectional view of a liquid crystal panel according to a preferred embodiment of the present invention. Description will be given of a liquid crystal panel for a reflective liquid crystal display apparatus. A liquid crystal panel 100 is provided with: a liquid crystal cell 20; a second optical compensation layer (C) 40 arranged below the liquid crystal cell 20; a first optical compensation layer (B) 30 arranged below the second optical compensation layer (C) 40; a polarizing plate 10 arranged below the first optical compensation layer (B) 30; a second optical compensation layer (C′) 40′ arranged above the liquid crystal cell 20; a first optical compensation layer (B′) 30′ arranged above the second optical compensation layer (C′) 40′; and a polarizing plate 10′ arranged above the first optical compensation layer (B′) 30′. The second optical compensation layer (C) 40 and the second optical compensation layer (C′) 40′ may be omitted depending on a purpose and an alignment mode of the liquid crystal cell. The liquid crystal cell 20 includes: a pair of glass substrates 21 and 21′; and a liquid crystal layer 22 as a display medium arranged between the substrates. A reflecting electrode 23 is provided on a liquid crystal layer 22 side of the lower substrate 21′. A color filter (not shown) is provided on the upper substrate 21. A distance (cell gap) between the substrates 21 and 21′ is controlled by a spacer 24. In the present invention, a laminate (such as second optical compensation layer/first optical compensation layer/polarizing plate) to be arranged on each side of the liquid crystal panel may be referred to “a polarizing plate provided with optical compensation layers”. By referring to FIG. 1, for example, a polarizing plate provided with optical compensation layers 500 is arranged below the liquid crystal cell, and a polarizing plate provided with optical compensation layers 500′ is arranged above the liquid crystal cell.

In the liquid crystal panel 100 of reflective VA mode, for example, liquid crystal molecules are aligned vertically to surfaces of the substrates 21 and 21′ under no voltage application. The vertical alignment may be realized by arranging nematic liquid crystals having negative dielectric anisotropy between substrates each having formed thereon a vertically aligned film (not shown). Linear polarized light allowed to pass through the polarizing plate 10′ from a surface of the upper substrate 21 entering the liquid crystal layer 22 in the state advances along long axes of vertically aligned liquid crystal molecules. No birefringence generates in a long axis direction of the liquid crystal molecules such that incident light advances without changing a polarization direction. The light is reflected by the reflecting electrode 23, is allowed to pass through the liquid crystal layer 22 again, and exits from the upper substrate 21. A polarization state of the exiting light is the same as that of the incident light, and the exiting light is allowed to pass through the polarizing plate 10′, to thereby provide light display. The long axes of the liquid crystal molecules align parallel to the surfaces of the substrates under voltage application between electrodes. The liquid crystal molecules exhibit birefringence with respect to linear polarized light entering the liquid crystal layer 22 in the state, and the polarization state of the incident light varies depending on inclination of the liquid crystal molecules. The light reflected by the reflecting electrode 23 and exiting from the upper substrate under application of a predetermined maximum voltage rotates its polarization direction by 90° into linear polarized light, for example, and is absorbed by the polarizing plate 10′, to thereby provide dark display. Return to a state under no voltage application provides light display again by alignment control force. The inclination of the liquid crystal molecules may be controlled by varying an application voltage to change an intensity of transmitted light from the polarizing plate 10′, to thereby provide gradient display.

FIG. 2 is an exploded perspective view explaining optical axes of layers forming the polarizing plate provided with optical compensation layers (second optical compensation layer/first optical compensation layer/polarizing plate) of FIG. 1. By referring to the polarizing plate provided with optical compensation layers 500 below the liquid crystal cell shown in FIG. 2, for example, the polarizing plate provided with optical compensation layers includes the polarizer (A) 11, the first optical compensation layer (B) 30, and the second optical compensation layer (C) 40 in the order given. The layers may be laminated through any appropriate pressure-sensitive adhesive layer or adhesive layer (not shown). For practical use, any appropriate protective film 15 (not shown) is laminated on the polarizer (A) 11 on a side having no first optical compensation layer (B) 30 formed. Any appropriate protective film 12 is preferably provided between the polarizer (A) 11 and the first optical compensation layer (B) 30. The protective films 12 and 15 are each preferably a transparent protective film, and more preferably a triacetyl cellulose film.

The first optical compensation layer (B) 30 and the first optical compensation layer (B′) 30′ each have refractive index profile of nx>ny=nz. The second optical compensation layer (C) 40 and the second optical compensation layer (C′) 40′ each have refractive index profile of nx>ny>nz.

In the present invention, as shown in FIG. 2, a slow axis b of the first optical compensation layer (B) 30 defines a predetermined angle +α° with respect to an absorption axis a of the polarizer (A) 11. Meanwhile, as shown in FIG. 3, a slow axis b′ of the first optical compensation layer (B′) 30′ defines a predetermined angle −α° with respect to an absorption axis a′ of the polarizer (A′) 11′. The angle α is 0<α<90, preferably 5 to 45, more preferably to 35, furthermore preferably 18 to 28, still more preferably to 25, particularly preferably 21 to 24, and most preferably 22 to 23.

In the present invention, in the case where the second optical compensation layer (C) 40 and the second optical compensation layer (C′) 40′ are provided, a slow axis c of the second optical compensation layer (C) 40 defines a predetermined angle +β° with respect to the absorption axis a of the polarizer (A) 11. Meanwhile, a slow axis c′ of the second optical compensation layer (C′) 40′ defines a predetermined angle +β° with respect to the absorption axis a′ of the polarizer (A′) 11′. The angle β is 85 to 95, preferably 87 to 93, more preferably 88 to 92, and most preferably 89 to 91.

A second optical compensation layer (C) 40 side of the polarizing plate provided with optical compensation layers 500 and a second optical compensation layer (C′) 40′ side of the polarizing plate provided with optical compensation layers 500′ are attached to both sides of the liquid crystal cell such that the absorption axis of the polarizer 11 in the polarizing plate provided with optical compensation layers 500 and the absorption axis of the polarizer 11′ in the polarizing plate provided with optical compensation layers 500′ are perpendicular to each other, to thereby provide a liquid crystal panel as shown in FIG. 1.

### A-2. First Optical Compensation Layer

The first optical compensation layer has refractive index profile of nx>ny=nz. Preferably, the first optical compensation layer may serve as a λ/2 plate. The first optical compensation layer serves as a λ/2 plate, to thereby appropriately adjust retardation of wavelength dispersion properties (in particular, a wavelength range where the retardation departs from λ/4) of the second optical compensation layer serving as a λ/4 plate. The first optical compensation layer has an in-plane retardation Re₁ of preferably 200 to 300 nm, more preferably 220 to 280 nm, and particularly preferably 230 to 270 nm.

In the present invention, a shift in in-plane retardation Re₁ between the first optical compensation layer (B) and the first optical compensation layer (B′) to be arranged on both sides of the liquid crystal cell is stably and significantly reduced. The shift (larger value-smaller value) in in-plane retardation Re₁ between the first optical compensation layer (B) and the first optical compensation layer (B′) is preferably as small as possible, preferably 7 nm or less, more preferably 5 nm or less, furthermore preferably 3 nm or less, and particularly preferably 2 nm or less. A shift (larger value-smaller value) in in-plane retardation Re₁ between the first optical compensation layer (B) and the first optical compensation layer (B′) of more than 7 nm may inhibit realization of high contrast of a liquid crystal panel and a liquid crystal display apparatus including the liquid crystal panel.

In the present invention, a thickness of the first optical compensation layer may be set such that it serves as a λ/2 plate most appropriately. That is, the thickness thereof is set to provide a desired retardation. Specifically, the thickness of the first optical compensation layer is preferably 0.5 to 5 μm, more preferably 1 to 4 μm, and most preferably 1.5 to 3 μm.

In the present invention, any appropriate material may be employed as a material used for forming the first optical compensation layer as long as the above-mentioned properties can be obtained. A liquid crystal material is preferred, and a liquid crystal material having a crystal phase of a nematic phase (nematic liquid crystals) is more preferred. Use of the liquid crystal material remarkably increases a difference between nx and ny of the optical compensation layer to be obtained compared with the case using a non-liquid crystal material. As a result, the thickness of the optical compensation layer can be remarkably reduced for obtaining a desired in-plane retardation. Examples of the liquid crystal material that may be used include a liquid crystal polymer and a liquid crystal monomer. The liquid crystal polymer and the liquid crystal monomer may be used in combination. The liquid crystal material may exhibit liquid crystallinity through a lyotropic or thermotropic mechanism. Further, liquid crystals are preferably aligned in homogeneous alignment.

A liquid crystal monomer used as the liquid crystal material is preferably a polymerizable monomer and/or a crosslinking monomer, for example. As described below, this is because the alignment state of the liquid crystal material can be fixed by polymerizing or crosslinking the polymerizable monomer or the crosslinking monomer. The alignment state of the liquid crystal monomer can be fixed by aligning the liquid crystal monomer, and then polymerizing or crosslinking the liquid crystal monomers (the polymerizable monomer or the crosslinking monomer), for example. A polymer is formed through polymerization, and a three-dimensional network structure is formed through crosslinking. The polymer and the three-dimensional network structure are not crystalline. Thus, the formed first optical compensation layer will not undergo phase transition into a liquid crystal phase, a glass phase, or a crystal phase by change in temperature, which is specific to a liquid crystal compound. As a result, the first optical compensation layer is an optical compensation layer which has excellent stability and is not affected by change in temperature. The polymerizable monomer and the crosslinking monomer may be used in combination.

Any suitable liquid crystal monomers may be employed as the liquid crystal monomer. For example, there are used polymerizable mesogenic compounds and the like described in JP 2002-533742 A (WO 00/37585), EP 358208 (U.S. Pat. No. 5,211,877), EP 66137 (U.S. Pat. No. 4,388,453), WO 93/22397, EP 0261712, DE 19504224, DE 4408171, GB 2280445, and the like. Specific examples of the polymerizable mesogenic compounds include: LC242 (trade name) available from BASF Aktiengesellschaft; E7 (trade name) available from Merck & Co., Inc.; and LC-Silicone-CC3767 (trade name) available from Wacker-Chemie GmbH.

For example, a nematic liquid crystal monomer is preferred as the liquid crystal monomer, and a specific example thereof includes a monomer represented by the below-indicated formula (L1). The liquid crystal monomer may be used alone or in combination of two or more thereof.

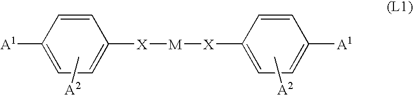

In the above formula (L1), A¹ and A² each represent a polymerizable group, and may be the same or different from each other. One of A¹ and A² may represent hydrogen. Each X independently represents a single bond, —O—, —S—, —C═N—, —O—CO—, —CO—O—, —O—CO—O—, —CO—NR—, —NR—CO—, —NR—, —O—CO—NR—, —NR—CO—O—, —CH₂—O—, or —NR—CO—NR—. R represents H or an alkyl group having 1 to 4 carbon atoms. M represents a mesogen group.

In the above formula (L1), Xs may be the same or different from each other, but are preferably the same. Of monomers represented by the above formula (L1), each A² is preferably arranged in an ortho position with respect to A¹.

A¹ and A² are preferably each independently represented by the below-indicated formula (L2), and A¹ and A² preferably represent the same group.

Z-X-(Sp)ₙ (L2)

In the above formula (L2), Z represents a crosslinkable group, and X is the same as that defined in the above formula (L1). Sp represents a spacer consisting of a substituted or unsubstituted linear or branched alkyl group having 1 to 30 carbon atoms. n represents 0 or 1. A carbon chain in Sp may be interrupted by oxygen in an ether functional group, sulfur in a thioether functional group, a non-adjacent imino group, an alkylimino group having 1 to 4 carbon atoms, or the like.

In the above formula (L2), Z preferably represents any one of functional groups represented by the below-indicated formulae. In the below-indicated formulae, examples of R include a methyl group, an ethyl group, an n-propyl group, an i-propyl group, an n-butyl group, an i-butyl group, and a t-butyl group.

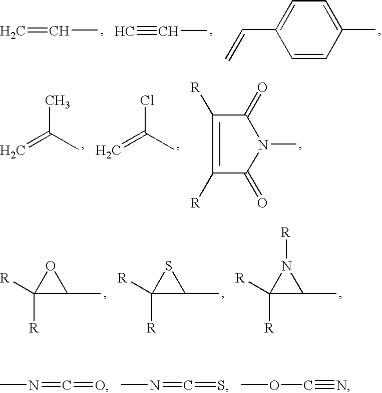

In the above formula (L2), Sp preferably represents any one of structural units represented by the below-indicated formulae. In the below-indicated formulae, m preferably represents 1 to 3, and p preferably represents 1 to 12.

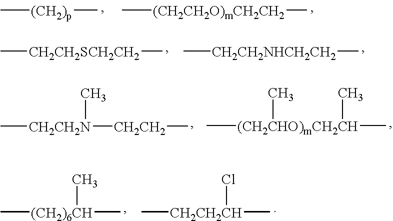

In the above formula (L1), M is preferably represented by the below-indicated formula (L3). In the below-indicated formula (L3), X is the same as that defined in the above formula (L1). Q represents a substituted or unsubstituted linear or branched alkylene group, or an aromatic hydrocarbon group, for example. Q may represent a substituted or unsubstituted linear or branched alkylene group having 1 to 12 carbon atoms, for example.

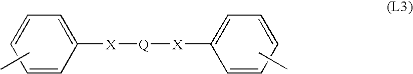

In the case where Q represents an aromatic hydrocarbon group, Q preferably represents any one of aromatic hydrocarbon groups represented by the below-indicated formulae or substituted analogues thereof.

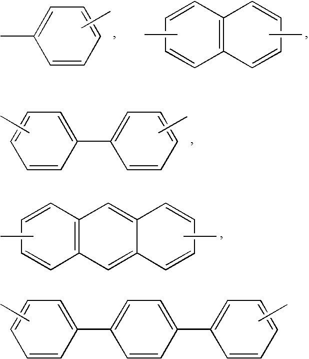

The substituted analogues of the aromatic hydrocarbon groups represented by the above formulae may each have 1 to 4 substituents per aromatic ring, or 1 to 2 substituents per aromatic ring or group. The substituents may be the same or different from each other. Examples of the substituents include: an alkyl group having 1 to carbon atoms; a nitro group; a halogen group such as F, Cl, Br, 4 or I; a phenyl group; and an alkoxy group having 1 to 4 carbon atoms. Specific examples of the liquid crystal monomer include monomers represented by the following formulae (L4) to (L19).

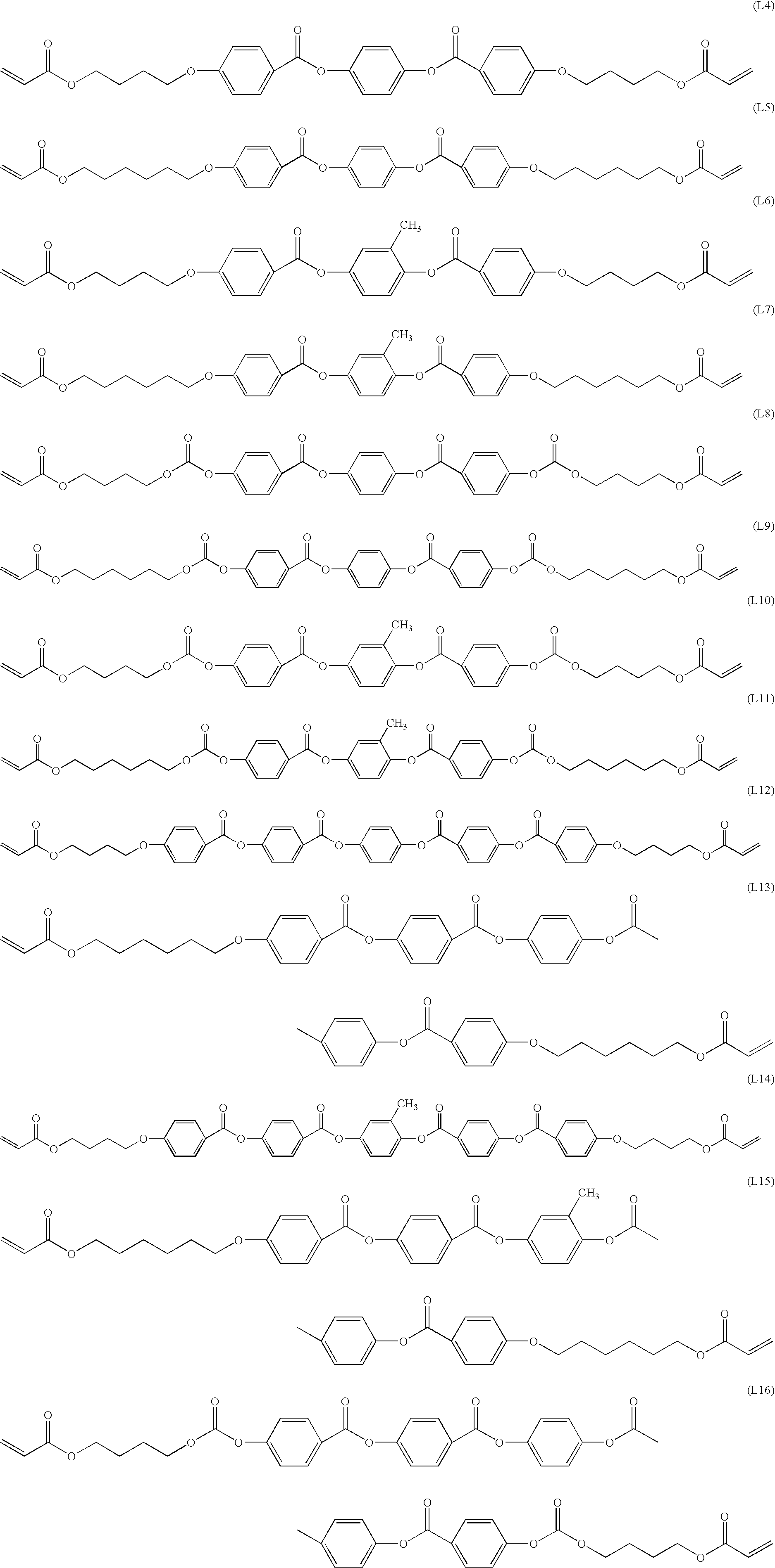

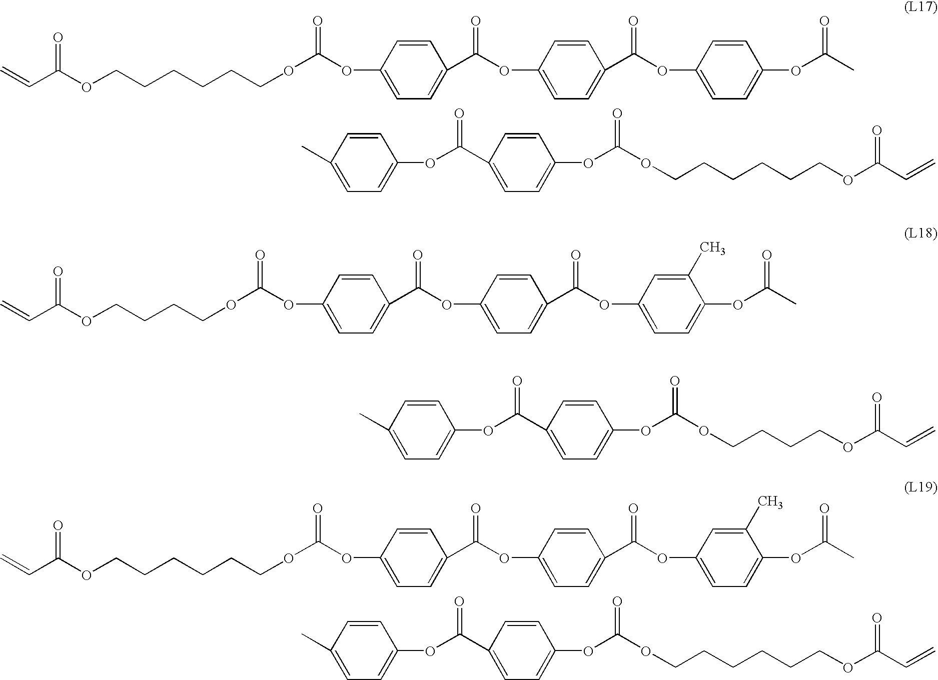

A temperature range in which the liquid crystal monomer exhibits liquid-crystallinity varies depending on the type of liquid crystal monomer. More specifically, the temperature range is preferably 40 to 120° C., more preferably 50 to 100° C., and most preferably 60 to 90° C.

### A-3. Second Optical Compensation Layer

In the present invention, the second optical compensation layer may be provided. The second optical compensation layer has a refractive index profile represented by nx>ny>nz.

The second optical compensation layer preferably satisfies an expression 0.97<Δnd(x)/Δnd(590)<1.05. Δnd(x) represents an in-plane retardation measured by using light of a wavelength x (450 nm≦x≦700 nm), and Δnd(590) represents an in-plane retardation measured by using light of a wavelength of 590 nm.

Δnd(x) and Δnd(590) of the second optical compensation layer are preferably 20 to 200 nm, more preferably 40 to 180 nm, and furthermore preferably 60 to 160 nm. In the present invention, Δnd(590) of the second optical compensation layer is preferably larger than Δnd(590) of the first optical compensation layer.

A thickness of the second optical compensation layer only needs to be set so as to provide a desired in-plane retardation. Specifically, the thickness thereof is preferably 1 to 15 μm more preferably 1.5 to 10 μm, and most preferably 2 to 8 μm in the case where the second optical compensation layer is obtained by coating. The thickness thereof is preferably 30 to 120 μm, more preferably to 100 μm, and most preferably 50 to 90 μm in the case where the second optical compensation layer is obtained as a film.

The second optical compensation layer is generally formed by subjecting a polymer film to stretching treatment. A second optical compensation layer having the desired optical characteristics (such as refractive index profile, in-plane retardation, thickness retardation, and Nz coefficient) may be obtained by appropriately selecting the type of polymer, stretching conditions, a stretching method, and the like.

Any appropriate polymer may be employed as a polymer constituting the polymer film. Specific examples of the polymer include a polycarbonate-based polymer (resin), a norbornene-based polymer (resin), a cellulose-based polymer (resin), a polyvinylalcohol-based polymer (resin), and a polysulfone-based polymer (resin).

Examples of a norbornene-based resin include: open-ring polymers (copolymers) of norbornene-based monomers; addition polymers of norbornene-based monomers; copolymers (typically random copolymers) of norbornene-based monomers and α-olefins such as ethylene and propylene; graft modified products obtained by modifying those polymers or copolymers with an unsaturated carboxylic acid or a derivative thereof; and hydrogenated products thereof.

Examples of the norbornene-based monomer to be used to provide a norbornene-based resin include: norbornene, and a derivative thereof substituted by alkyl and/or alkylidene such as 5-methyl-2-norbornene, 5-dimethyl-2-norbornene, 5-ethyl-2-norbornene, 5-butyl-2-norbornene, 5-ethylidene-2-norbornene, or a derivative thereof substituted by a polar group such as a halogen; dicyclopentadiene, 2,3-dihydrodicyclopentadiene, or the like; dimethanooctahydronaphthalene, a derivative thereof substituted by alkyl and/or alkylidene, and a derivative thereof substituted by a polar group such as a halogen, such as 6-methyl-1,4:5,8-dimethano-1,4,4a,5,6,7,8,8a-octahydronaphthalene, 6-ethyl-1,4:5,8-dimethano-1,4,4a,5,6,7,8,8a-octahydronaphthalene, 6-ethinyliden-1,4:5,8-dimethano-1,4,4a,5,6,7,8,8a-octahydronaphthalene, 6-chloro-1,4:5,8-dimethano-1,4,4a,5,6,7,8,8a-octahydronaphthalene, 6-cyano-1,4:5,8-dimethano-1,4,4a,5,6,7,8,8a-octahydronaphthalene, 6-pyridyl-1,4:5,8-dimethano-1,4,4a,5,6,7,8,8a-octahydronaphthalene, or 6-methoxycarbonyl-1,4:5,8-dimethano-1,4,4a,5,6,7,8,8a-octahydronaphthalene; and a trimer or tetramer of cyclopentadiene such as 4,9:5,8-dimethano-3a,4,4a,5,8,8a,9,9a-octahydro-1H-benzoindene, or 4,11:5,10:6,9-trimethano-3a,4,4a,5,5a,6,9,9a,10,10a,11,11a-dodecahydro-1H-cyclopentaanthracene. One kind of the norbornene-based monomers may be used alone, or two or more kinds of them may be used together.

To obtain a norbornene-based resins, apart from norbornene-based monomers, other cycloolefins which may be subjected to ring opening polymerization, as cyclic olefins, may be used in combination within a range not inhibiting the effect of the present invention. A specific example of the cycloolefin is a compound having one reactive double bond such as cyclopentene, cyclooctene, or 5,6-dihydrodicyclopentadiene.

The norbornene-based resin has a number average molecular weight (Mn) of preferably 25,000 to 200,000, more preferably 30,000 to 100,000, and most preferably 40,000 to 80,000 measured through a gel permeation chromatography (GPC) method by using a toluene solvent. A number average molecular weight within the above ranges can provide excellent mechanical strength, and favorable solubility, forming property, and operability.

In the case where the norbornene-based resin is prepared through hydrogenation of a ring opened polymer of a norbornene-based monomer, a hydrogenation rate is preferably 90% or more, more preferably 95% or more, and most preferably 99% or more. A hydrogenation rate within the above ranges can provide excellent heat degradation resistance and light degradation resistance.

Various products of the norbornene-based resin are commercially available. Specific examples thereof include ZEONEX and ZEONOR, trade names, available from Zeon Corporation; Arton, available from JSR Corporation; and Topas available from Ticona.

### A-4. Polarizer

Any suitable polarizers may be employed as the polarizer in accordance with the purpose. Examples thereof include: a film prepared by adsorbing a dichromatic substance such as iodine or a dichromatic dye on a hydrophilic polymer film such as a polyvinyl alcohol-based film, a partially formalized polyvinyl alcohol-based film, or a partially saponified ethylene/vinyl acetate copolymer-based film and uniaxially stretching the film; and a polyene-based orientation film such as a dehydrated product of a polyvinyl alcohol-based film or a dechlorinated product of a polyvinyl chloride-based film. Of those, a polarizer prepared by adsorbing a dichromatic substance such as iodine on a polyvinyl alcohol-based film and uniaxially stretching the film is particularly preferred because of high polarized dichromaticity. A thickness of the polarizer is not particularly limited, but is generally about 1 to 80 μm.

The polarizer prepared by adsorbing iodine on a polyvinyl alcohol-based film and uniaxially stretching the film may be produced by, for example: immersing a polyvinyl alcohol-based film in an aqueous solution of iodine for coloring; and stretching the film to a 3 to 7 times length of the original length. The aqueous solution may contain boric acid, zinc sulfate, zinc chloride, or the like as required, or the polyvinyl alcohol-based film may be immersed in an aqueous solution of potassium iodide or the like. Further, the polyvinyl alcohol-based film may be immersed and washed in water before coloring as required.

Washing the polyvinyl alcohol-based film with water not only allows removal of contamination or an antiblocking agent on a film surface, but also provides an effect of preventing nonuniformity such as uneven coloring by swelling of the polyvinyl alcohol-based film. The stretching of the film may be performed after coloring of the film with iodine, performed during coloring of the film, or performed followed by coloring of the film with iodine. The stretching may be performed in an aqueous solution of boric acid or potassium iodide, or in a water bath.

### A-5. Protective Film

In the present invention, the protective films 12 and 15 each employ any appropriate film which can be used as a protective film a polarizer. Specific examples of a material to be included as a main component of the film include: a cellulose-based resin such as triacetyl cellulose (TAC); and a transparent resin such as a polyester-based resin, a polyvinyl alcohol-based resin, a polycarbonate-based resin, a polyamide-based resin, a polyimide-based resin, a polyethersulfone-based resin, a polysulfone-based resin, a polystyrene-based resin, a polynorbornene-based resin, a polyolefin-based resin, an acrylic resin, or an acetate-based resin. Other examples thereof include: a thermosetting resin such as an acrylic resin, a urethane-based resin, an acrylurethane-based resin, an epoxy-based resin, or a silicone-based resin; and a UV-curable resin. Still another example thereof is a glassy polymer such as a siloxane-based polymer. Further, a polymer film described in JP-A-2001-343529 (WO01/37007) may also be used. A material for the film may employ a resin composition containing a thermoplastic resin having a substituted or unsubstituted imide group on a side chain, and a thermoplastic resin having a substituted or unsubstituted phenyl group and nitrile group on a side chain, for example. A specific example thereof is a resin composition containing an alternating isobutene/N-methylmaleimide copolymer, and a acrylonitrile/styrene copolymer. The polymer film may be an extrusion molded product of the resin composition described above, for example. TAC, a polyimide-based resin, a polyvinyl alcohol-based resin, and a glassy polymer are preferred, and TAC is more preferred.

It is preferable that the protective film be transparent and have no color. Specifically, the protective film has a thickness retardation of preferably −90 nm to +90 nm, more preferably −80 nm to +80 nm, and most preferably −70 nm to +70 nm.

The protective film has any appropriate thickness as long as the preferable thickness retardation can be obtained. Specifically, the thickness of the protective film is preferably 5 mm or less, more preferably 1 mm or less, particularly preferably 1 to 500 μm, and most preferably 5 to 150 μm.

The protective films 12 and 15 may be identical to or different from each other. The protective film 15 may be subjected to hard coat treatment, antireflection treatment, anti-sticking treatment, antiglare treatment, and the like as required.

### A-6. Other Structural Components

The liquid crystal panel of the present invention may be provided with other optical layers. As the other optical layers, appropriate optical layers may be employed in accordance with the purpose and the types of liquid crystal panel and image display apparatus. Specific examples thereof include a liquid crystal film, a light scattering film, a diffraction film, and another optical compensation layer (retardation film).

The liquid crystal panel of the present invention may further include a pressure-sensitive adhesive layer or adhesive layer as an outermost layer on at least one side of the polarizing plate provided with optical compensation layers (such as second optical compensation layer/first optical compensation layer/polarizing plate). In this way, the liquid crystal panel includes the pressure-sensitive adhesive layer or adhesive layer as an outermost layer, to thereby facilitate lamination with the liquid crystal cell and prevent peeling off of the polarizing plate provided with optical compensation layers from the liquid crystal cell, for example. A material used for forming the pressure-sensitive adhesive layer or adhesive layer may employ any appropriate material. Preferably, a material having excellent moisture absorption property or excellent heat resistance is used for preventing foaming or peeling due to moisture absorption, degradation in optical properties due to difference in thermal expansion or the like, warping of the liquid crystal cell, and the like.

For practical use, a surface of the pressure-sensitive adhesive layer or adhesive layer is covered by any appropriate separator to prevent contamination until the polarizing plate provided with optical compensation layer is actually used. The separator may be formed by a method of providing a release coat on any appropriate film by using a releasing agent such as a silicone-based, long chain alkyl-based, or fluorine-based releasing agent, molybdenum sulfide, or the like as required.

Each of the layers of the polarizing plate provided with optical compensation layers of the present invention may be subjected to treatment with a UV absorbing agent such as a salicylate-based compound, a benzophenone-based compound, a benzotriazole-based compound, a cyanoacrylate-based compound, or a nickel complex-based compound, to thereby impart UV absorbing property.

### B. Method of Producing Liquid Crystal Panel

A method of producing a liquid crystal panel of the present invention refers to a method of producing a liquid crystal panel including a first optical compensation layer having refractive index profile of nx>ny=nz and a polarizer on each side of a liquid crystal cell in the order given, in which an angle formed between an absorption axis of the polarizer (A) and a slow axis of the first optical compensation layer (B) on one side of the liquid crystal cell is +α°, an angle formed between an absorption axis of the polarizer (A′) and a slow axis of the first compensation layer (B′) on another side of the liquid crystal cell is −α°, and 0<α<90. The method of producing a liquid crystal panel comprises: a step of subjecting a surface of a continuous substrate formed of single original sheet to alignment treatment at +α° and alignment treatment at −α° with respect to a longitudinal direction of the substrate; and a step of forming the first optical compensation layer (B) on the surface subjected to the +α° alignment treatment and forming the first optical compensation layer (B′) on the surface subjected to the −α° alignment treatment.

The substrate to be used in the present invention may employ any appropriate substrate. The substrate may be a monolayer, or a laminate formed of a plurality of layers. A specific example of the laminate is a laminate formed of “polarizer protective film/polarizer/polarizer protective film”. A film (specifically, the first optical compensation layer) formed on the substrate may be transferred (laminated) in an appropriate order in accordance with a desired laminate structure of optical films. The substrate to be used in the present invention is a substrate formed of single original sheet. The substrate is formed of preferably single original sheet having a total length (a length in a longitudinal direction) of 500 to 10,000 m, more preferably single original sheet having a total length of 500 to 8,000 m, furthermore preferably single original sheet having a total length of 500 to 6,000 m, still more preferably single original sheet having a total length of 500 to 3,000 m, particularly preferably single original sheet having a length of 500 to 2,000 m, and most preferably single original sheet having a length of 1,000 to 2,000 m. The substrate is formed of preferably single original sheet having a total width (a width in a width direction) of 100 to 2,000 mm, more preferably single original sheet having a total width of 200 to 1,500 mm, furthermore preferably single original sheet having a total width of 300 to 1,200 mm, particularly preferably single original sheet having a width of 300 to 1,000 mm, and most preferably single original sheet having a width of 300 to 700 mm. A total length (the length in a longitudinal direction) and a total width (the length in a width direction) of the substrate departing from the above ranges may cause difficulties in stable production.

In the case where the substrate to be used in the present invention is eventually used for a protective film of a polarizing plate (polarizer protective film), specific examples of a material to be included as a main component of the film include: a cellulose-based resin such as triacetyl cellulose (TAC); and a transparent resin such as a polyester-based resin, a polyvinyl alcohol-based resin, a polycarbonate-based resin, a polyamide-based resin, a polyimide-based resin, a polyethersulfone-based resin, a polysulfone-based resin, a polystyrene-based resin, a polynorbornene-based resin, a polyolefin-based resin, an acrylic resin, or an acetate-based resin. Other examples thereof include: a thermosetting resin such as an acrylic resin, a urethane-based resin, an acrylurethane-based resin, an epoxy-based resin, or a silicone-based resin; and a UV-curable resin. Still another example thereof is a glassy polymer such as a siloxane-based polymer. Further, a polymer film described in JP-A-2001-343529 (WO01/37007) may also be used. A material for the film may employ a resin composition containing a thermoplastic resin having a substituted or unsubstituted imide group on a side chain, and a thermoplastic resin having a substituted or unsubstituted phenyl group and nitrile group on a side chain, for example. A specific example thereof is a resin composition containing an alternating isobutene/N-methylmaleimide copolymer, and a acrylonitrile/styrene copolymer. The polymer film may be an extrusion molded product of the resin composition described above, for example. TAC, a polyimide-based resin, a polyvinyl alcohol-based resin, and a glassy polymer are preferred. The film is preferably transparent and colorless. That is the film is preferably a transparent protective film. Specifically, the film has a thickness direction retardation of preferably −90 nm to +90 nm, more preferably −80 nm to +80 nm, and most preferably −70 nm to +70 nm.

In the case where the substrate is eventually used as a protective film of a polarizing plate (polarizer protective film), the thickness of the substrate may employ any appropriate thickness as long as the preferred thickness direction retardation can be obtained. The thickness is preferably 5 mm or less, more preferably mm or less, furthermore preferably 1 to 500 μm, and particularly preferably 5 to 150 μm.

In the case where the substrate to be used in the present invention is eventually peeled off after the optical compensation layer formed thereon is transferred, specific examples of a material to be included as a main component of the substrate include a glass substrate, a metal foil, a plastic sheet, and a plastic film. Note that an aligned film may be or may not be provided on the substrate. The plastic film may employ any appropriate film. Specific examples thereof include films formed of transparent polymers including: polyester-based polymers such as polyethylene terephthalate and polyethylene naphthalate; cellulose-based polymers such as diacetylcellulose and triacetylcellulose; polycarbonate-based polymers; and acrylic polymers such as polymethylmethacrylate. Further examples of the plastic film include films formed of transparent polymers including: styrene-based polymers such as polystyrene and an acrylonitrile/styrene copolymer; olefin-based polymers such as polyethylene, polypropylene, polyolefin having a cyclic or norbornene structure, and an ethylene/propylene copolymer; vinyl chloride-based polymers; and amide-based polymers such as nylon and aromatic polyamide. Further examples of the plastic film include films formed of transparent polymers including imide-based polymers, sulfone-based polymers, polyethersulfone-based polymers, polyetheretherketone-based polymers, polyphenylenesulfide-based polymers, vinyl alcohol-based polymers, vinylidene chloride-based polymers, vinyl butyral-based polymers, arylate-based polymers, polyoxymethylene-based polymers, epoxy-based polymers, and blended products thereof. Of those, a polyethyleneterephthalate (PET) film is preferable.

In the case where the substrate to be used in the present invention is eventually peeled off after the optical compensation layer formed thereon is transferred, the thickness of the substrate is preferably 20 to 100 μm, more preferably 30 to 90 μm, and furthermore preferably 30 to 80 μm. The substrate has a thickness within the above ranges, to thereby provide strength for favorable support in a step of forming an extremely thin optical compensation layer and appropriately maintain operability such as sliding property and roll traveling property.

### B-1. Alignment Treatment of Substrate

As shown in FIGS. 4 and 5, a surface of the continuous substrate 13 (may be perceived as the protective film 12 in the case where the substrate is eventually used as the polarizer protective film) formed of single original sheet is subjected to alignment treatment at +α° and alignment treatment at −α° with respect to the longitudinal direction, and an application liquid containing a predetermined liquid crystal material is applied to the surface, to thereby form the first optical compensation layer (B) 30 and the first optical compensation layer (B′) 30′ on the continuous substrate 13 formed of single original sheet. In this case, the first optical compensation layers (B) and (B′) are each preferably formed by using an application liquid of the same lot. In general, the application liquid contains a liquid crystal material, one type of solvent or two or more types of solvent, and a polymerization initiator, for example. In this way, the application liquid generally contains a polymerization initiator. Thus, a prepared application liquid undergoes a relatively rapid chemical reaction and increases in viscosity. Thus, application may involve difficulties, and desired properties may not be obtained. Further, uniform stirring of a large amount of the application liquid involves difficulties, and the stirred application liquid may separate after being left standing for a long period of time. In the case where the first optical compensation layers are formed on separate substrates, application liquids of different lots prepared for respective cases must be used. Meanwhile, use of an application liquid of the same lot eliminates nonuniformity due to properties (a molecular weight distribution, an amount of impurities, and the like) of the liquid crystal material by production lot. As a result, shift in retardation can be reduced. Use of the application liquid of the same lot eliminates nonuniformity due to the concentration or composition ratio of the application liquid to be used. As a result, shift in retardation can be reduced.

The first optical compensation layer (B) 30 (an angle formed between the absorption axis of the polarizer (A) 11 and the slow axis of the first optical compensation layer (B) 30 of +α°) and the first optical compensation layer (B′) 30′ (an angle formed between the absorption axis of the polarizer (A′) 11′ and the slow axis of the first optical compensation layer (B′) 30′ of −α°) to be obtained in the above step are not produced from substrates formed of separate original sheets as in a conventional case and are produced from a continuous substrate formed of single original sheet. Thus, shift in in-plane retardation Re₁ between the first optical compensation layer (B) 30 and the first optical compensation layer (B′) 30′ can be stably and significantly reduced. In this way, the first optical compensation layer (B) 30 and the first optical compensation layer (B′) 30′ which are produced from the continuous substrate formed of single original sheet are arranged on both sides of the liquid crystal cell for production of a liquid crystal panel and a liquid crystal display apparatus, to thereby realize high contrast easily at low cost.

The alignment treatment of the substrate may employ any appropriate alignment treatment. Specific examples thereof include rubbing treatment, an oblique evaporation method, stretching treatment, photoalignment treatment, magnetic field alignment treatment, and electric field alignment treatment. A preferred example thereof is rubbing treatment. Treatment conditions for various alignment treatments may employ any appropriate conditions in accordance with the purpose.

An alignment direction of the alignment treatment is a direction forming a predetermined angle (+α° or −α°) with the absorption axis of the polarizer in lamination with the polarizer. An alignment direction of +α° is substantially identical to a direction of the slow axis b of the first optical compensation layer (B) to be formed, and an alignment direction of −α° is substantially identical to a direction of the slow axis b′ of the first optical compensation layer (B′) to be formed. The angle α is 0<α<90, preferably 5 to 45, more preferably 10 to 35, furthermore preferably 18 to 28, still more preferably 19 to 25, particularly preferably 21 to 24, and most preferably 22 to 23.

Examples of such alignment treatment for defining a predetermined angle with respect to the continuous substrate as described above include: treatment in a longitudinal direction of the continuous substrate; and treatment in an oblique direction (specifically, a direction defining the predetermined angle) with respect to the longitudinal direction of the continuous substrate or a vertical direction thereto (a width direction). The polarizer is produced by stretching a polymer film colored with a dichromatic substance as described above, and has an absorption axis in a stretching direction. For mass production of the polarizer, a continuous polymer film is prepared and is continuously stretched in a longitudinal direction. For production of the polarizing plate provided with optical compensation layers, lamination is preferably conducted such that the longitudinal direction of the continuous substrate is in the same direction as a direction of the absorption axis of the polarizer. In this way, for alignment in a direction forming a predetermined angle with respect to the absorption axis of the polarizer, alignment treatment in an oblique direction is desirably conducted. The direction of the absorption axis of the polarizer and the longitudinal direction of the continuous substrate are substantially identical, and thus the alignment treatment may be conducted in a direction forming the predetermined angle with respect to the longitudinal direction. Meanwhile, for treatment in the longitudinal direction or width direction of the continuous substrate, the substrate must be cut out in an oblique direction for lamination. Thus, angles of optical axes of cut out films may vary. As a result, quality may vary by products, and much cost and time may be required. Further, waste increases, and production of a large film involves difficulties.

The method of subjecting the surface of the continuous substrate formed of single original sheet to alignment treatment at +α° and alignment treatment at −α° with respect to the longitudinal direction may employ any appropriate method. A typical example thereof is a method involving rubbing treatment at +α° and rubbing treatment at −α° with respect to the longitudinal direction alternately for predetermined periods of time. In this case, the rubbing treatment may be conducted alternately and continuously as shown in FIG. 4. Further, as shown in FIG. 5, one rubbing treatment may be conducted for a predetermined period of time, and then the other rubbing treatment may be conducted for a predetermined period of time after a non-rubbing part (P). In consideration of easy production, the surface of the continuous substrate formed of single original sheet is continuously subjected to alignment treatment at +α° (or −α°) for a predetermined period of time, and then is continuously subjected to alignment treatment at an angle of an opposite sign −α° (or +α°) for a predetermined period of time, to thereby complete the alignment treatment of the substrate formed of single original sheet. In this case, in consideration of eventually arranging the polarizing plate provided with optical compensation layers obtained after the +α° alignment treatment and the polarizing plate provided with optical compensation layers obtained after the −α° alignment treatment on upper and lower surfaces of the liquid crystal cell, a length subjected to the +α° alignment treatment (a length of the substrate in a longitudinal direction) and a length subjected to the −α° alignment treatment (a length of the substrate in a longitudinal direction) are preferably substantially equal.

The substrate surface may be directly subjected to the alignment treatment. Alternatively, any appropriate aligned layer (typically, a polyimide layer, a polyvinyl alcohol layer, a silane coupling layer, or the like) may be formed, and the aligned layer may be subjected to the alignment treatment. For example, the substrate surface is preferably directly subjected to rubbing treatment because the rubbing treatment of the aligned layer involves the following disadvantages in formation of the aligned layer. In the case where the aligned layer is a polyimide layer: (1) a solvent which does not corrode the substrate must be selected, and thus selection of a solvent for an aligned layer forming composition involves difficulties; (2) curing at high temperatures (150 to 300° C., for example) is required, and thus an elliptical polarizing plate to be obtained may have poor appearance. In the case where the aligned layer is a polyvinyl alcohol layer, the aligned layer has insufficient heat resistance and moisture resistance, and thus the substrate and the aligned layer may peel off under high temperature and high humidity. As a result, clouding may be caused. Further, in the case where the aligned layer is a silane coupling layer, a liquid crystal layer (first optical compensation layer) to be formed is easily inclined, and realization of desired positive uniaxial property may involve difficulties.

### B-2. Step of Applying Liquid Crystal Material Forming First Optical Compensation Layer

Next, the application liquid containing a liquid crystal material as described in the above section A-2 is applied to the substrate surface subjected to alignment treatment, and the liquid crystal material is aligned, to thereby form the first optical compensation layer (B) and the first optical compensation layer (B′). Specifically, the application liquid is prepared by dissolving or dispersing a liquid crystal material in an appropriate solvent, and the application liquid is applied to the substrate surface subjected to the alignment treatment. The step of aligning a liquid crystal material will be described in the section B-3 described below.

Any suitable solvents which may dissolve or disperse the liquid crystal material may be employed as the solvent. The type of solvent to be used may be appropriately selected in accordance with the type of liquid crystal material or the like. Specific examples of the solvent include: halogenated hydrocarbons such as chloroform, dichloromethane, carbon tetrachloride, dichloroethane, tetrachloroethane, methylene chloride, trichloroethylene, tetrachloroethylene, chlorobenzene, and orthodichlorobenzene; phenols such as phenol, p-chlorophenol, o-chlorophenol, m-cresol, o-cresol, and p-cresol; aromatic hydrocarbons such as benzene, toluene, xylene, mesitylene, methoxybenzene, and 1,2-dimethoxybenzene; ketone-based solvents such as acetone, methyl ethyl ketone (MEK), methyl isobutyl ketone, cyclohexanone, cyclopentanone, 2-pyrrolidone, and N-methyl-2-pyrrolidone; ester-based solvents such as ethyl acetate, butyl acetate, and propyl acetate; alcohol-based solvents such as t-butyl alcohol, glycerin, ethylene glycol, triethylene glycol, ethylene glycol monomethyl ether, diethylene glycol dimethyl ether, propylene glycol, dipropylene glycol, and 2-methyl-2,4-pentanediol; amide-based solvents such as dimethylformamide and dimethylacetamide; nitrile-based solvents such as acetonitrile and butyronitrile; ether-based solvents such as diethyl ether, dibutyl ether, tetrahydrofuran, and dioxane; and carbon disulfide, ethyl cellosolve, butyl cellosolve, and ethyl cellosolve acetate. Of those, toluene, xylene, mesitylene, MEK, methyl isobutyl ketone, cyclohexanone, ethyl cellosolve, butyl cellosolve, ethyl acetate, butyl acetate, propyl acetate, and ethyl cellosolve acetate are preferred. The solvent may be used alone or in combination of two or more types thereof.

A content of the liquid crystal material in the liquid crystal composition (application liquid) may be appropriately determined in accordance with the type of liquid crystal material, the thickness of the target layer, and the like. More specifically, the content of the liquid crystal material is preferably 5 to 50 wt %, more preferably 10 to 40 wt %, and most preferably 15 to 30 wt %.

The liquid crystal composition (application liquid) may further contain any suitable additives as required. Specific examples of the additive include a polymerization initiator and a crosslinking agent. The additive is particularly preferably used when a liquid crystal monomer is used as the liquid crystal material. Specific examples of the polymerization initiator include benzoylperoxide (BPO) and azobisisobutyronitrile (AIBN). Specific examples of the crosslinking agent include an isocyanate-based crosslinking agent, an epoxy-based crosslinking agent, and a metal chelate crosslinking agent. Such additive may be used alone or in combination of two or more thereof. Specific examples of other additives include an antioxidant, a modifier, a surfactant, a dye, a pigment, a discoloration inhibitor, and a UV absorber. Such additive may also be used alone or in combination of two or more thereof. Examples of the antioxidant include a phenol-based compound, an amine-based compound, an organic sulfur-based compound, and a phosphine-based compound. Examples of the modifier include glycols, silicones, and alcohols. The surfactant is used for smoothing a surface of an optical film (that is, the first birefringent layer to be formed), for example. Specific examples thereof include a silicone-based surfactant, an acrylic surfactant, and a fluorine-based surfactant.

An application amount of the application liquid may be appropriately determined in accordance with a concentration of the application liquid, the thickness of the target layer, and the like. In a case where the concentration of the liquid crystal material is 20 wt % in the application liquid, the application amount is preferably 0.03 to 0.17 ml, more preferably 0.05 to 0.15 ml, and most preferably 0.08 to 0.12 ml per 100 cm² of the transparent protective film.

Any appropriate application method may be employed, and specific examples thereof include roll coating, spin coating, wire bar coating, dip coating, extrusion, curtain coating, and spray coating. An application speed may employ any appropriate application speed. Specifically, the application speed is preferably 50 to 5,000 m per hour, more preferably 100 to 3,000 m per hour, and furthermore preferably 200 to 1,000 m per hour. An application time may employ any appropriate application time. Specifically, the application time is preferably 30 min to 10 hours, more preferably 1 hour to 7 hours, and furthermore preferably 2 hours to 5 hours.

### B-3. Step of Aligning Liquid Crystal Material Forming First Optical Compensation Layer

Next, the liquid crystal materials forming the first optical compensation layer (B) and first optical compensation layer (B′) are aligned in accordance with the alignment direction of the surface of the substrate. The liquid crystal materials are aligned through treatment at a temperature exhibiting a liquid crystal phase in accordance with the type of each of liquid crystal materials used. The treatment at the temperature allows the liquid crystal materials to be in a liquid crystal state, and the liquid crystal materials are aligned in accordance with the alignment direction of the surface of the substrate. Thus, birefringence is caused in the layer formed through application, to thereby form the first optical compensation layer (B) and first optical compensation layer (B′).

A treatment temperature may be arbitrarily determined in accordance with the type of each of liquid crystal materials. Specifically, the treatment temperature is preferably 40 to 120° C., more preferably 50 to 100° C., and most preferably 60 to 90° C. A treatment time is preferably 30 seconds or more, more preferably 1 minute or more, particularly preferably 2 minutes or more, and most preferably 4 minutes or more. The treatment time of less than 30 seconds may provide an insufficient liquid crystal state of the liquid crystal material. Meanwhile, the treatment time is preferably 10 minutes or less, more preferably 8 minutes or less, and most preferably 7 minutes or less. The treatment time exceeding 10 minutes may cause sublimation of additives.

In a case where the liquid crystal monomer (the polymerizable monomer and/or the crosslinking monomer) as described in the section A-2 is used as the liquid crystal material, the layer formed through the application is preferably subjected to polymerization treatment or crosslinking treatment. The polymerization treatment allows the liquid crystal monomer to polymerize and to be fixed as a repeating unit of a polymer molecule. The crosslinking treatment allows the liquid crystal monomer to form a three-dimensional structure and to be fixed as a part of a crosslinked structure. As a result, the alignment state of the liquid crystal material is fixed. The polymer or three-dimensional structure formed through polymerization or crosslinking of the liquid crystal monomer is “non-liquid crystal”. Thus, the formed first optical compensation layer will not undergo phase transition into a liquid crystal phase, a glass phase, or a crystal phase by change in temperature, which is specific to a liquid crystal molecule. As a result, there can be obtained a first optical compensation which has excellent stability and is not affected by temperature.

A specific procedure for the polymerization treatment or crosslinking treatment may be arbitrarily selected in accordance with the type of polymerization initiator or crosslinking agent to be used. For example, in a case where a photopolymerization initiator or a photocrosslinking agent is used, photoirradiation may be performed. In a case where a UV polymerization initiator or a UV crosslinking agent is used, UV irradiation may be performed. In a case where a thermal polymerization initiator or a thermal crosslinking agent is used, heating may be performed. The irradiation time, irradiation intensity, total amount of irradiation, temperature at irradiation, and the like of light or UV light may be arbitrarily set in accordance with the type of liquid crystal material, the type of transparent protective film, the type of alignment treatment, desired characteristics for the first optical compensation layer, and the like. Also, heating temperature, heating time, and the like may be arbitrary set.

The alignment treatment is performed to align the liquid crystal material in the alignment direction of the substrate. Thus, the direction of the slow axis b of the first optical compensation layer (B) formed is substantially the same as the alignment direction of +α° of the substrate, and the direction of the slow axis b′ of the first optical compensation layer (B′) formed is substantially the same as the alignment direction of −α° of the substrate. The direction of the slow axis b of the first optical compensation layer (B) is +0° to +90°, preferably +5° to +45°, more preferably +10° to +35°, more preferably +18° to +28°, more preferably +19° to +25°, particularly preferably +21° to +24°, and most preferably +22° to +23° with respect to the longitudinal direction of the substrate. The direction of the slow axis b′ of the first optical compensation layer (B′) is −0° to −90°, preferably −5° to −45°, more preferably −10° to −35°, more preferably −18° to −28°, more preferably −19° to −25°, particularly preferably −21° to −24°, and most preferably −22° to −23° with respect to the longitudinal direction of the substrate.

### B-4. Step of Laminating Polarizer

B-4-1. Case where Substrate is Protective Film and Serves as Polarizer Protective Film

The polarizer is laminated on the surface of the substrate (in this case, protective film) opposite to the surface subjected to the alignment treatment. The polarizer is laminated at any appropriate point in time in the production method of the present invention. For example, the polarizer may be laminated on the protective layer in advance, may be laminated after the first optical compensation layer is formed, or may be laminated after the second optical compensation layer is formed. Another protective film may be attached on the surface of the polarizer opposite to the protective film.

Any appropriate lamination method (bonding, for example) may be employed as the method of laminating the protective film and the polarizer. The bonding may be performed by using any appropriate adhesive or pressure-sensitive adhesive. The type of adhesive or pressure-sensitive adhesive may arbitrarily selected in accordance with the type of adherent (that is, the protective film and the polarizer). Specific examples of the adhesive include: polymer adhesives such as an acrylic adhesive, a vinyl alcohol-based adhesive, a silicone-based adhesive, a polyester-based adhesive, a polyurethane-based adhesive, and a polyether-based adhesive; isocyanate-based adhesives; and rubber-based adhesives. Specific examples of the pressure-sensitive adhesive include an acrylic pressure-sensitive adhesive, a vinyl alcohol-based pressure-sensitive adhesive, a silicone-based pressure-sensitive adhesive, a polyester-based pressure-sensitive adhesive, a polyurethane-based pressure-sensitive adhesive, a polyether-based pressure-sensitive adhesive, an isocyanate-based pressure-sensitive adhesive, and a rubber-based pressure-sensitive adhesive.

The thickness of the adhesive or pressure-sensitive adhesive is not particularly limited, but is preferably 10 to 200 nm, more preferably 30 to 180 nm, and most preferably 50 to 150 nm.

The layer formed of a pressure-sensitive adhesive or adhesive is preferably a layer formed of a polyvinyl alcohol-based adhesive. The polyvinyl alcohol-based adhesive preferably contains a polyvinyl alcohol-based resin and a crosslinking agent.

Examples of the above-mentioned polyvinyl alcohol-based resin is not particularly limited, but include: a polyvinyl alcohol obtained by saponifying polyvinyl acetate; derivatives thereof; a saponified product of a copolymer obtained by copolymerizing vinyl acetate with a monomer having copolymerizability with vinyl acetate; and a modified polyvinyl alcohol obtained by modifying polyvinyl alcohol to acetal, urethane, ether, graft compound, phosphate, or the like. Examples of the monomer include: unsaturated carboxylic acids such as maleic anhydrides or maleic acid, fumaric acid, crotonic acid, itaconic acid, and (meth)acrylic acid and esters thereof; α-orefin such as ethylene and propylene; (sodium)(meth)allylsulfonate; sodium sulfonate (monoalkylmalate); sodium disulfonate alkylmalate; N-methylol acrylamide; alkali salts of acrylamide alkylsulfonate; N-vinylpyrrolidone; and derivatives of N-vinylpyrrolidone. The polyvinyl alcohol-based resins may be used alone or two or more them may be used in combination.

The polyvinyl alcohol-based resin has an average degree of polymerization of preferably 100 to 3,000, and more preferably 500 to 3,000, and an average degree of saponification of preferably to 100 mol %, and more preferably 90 to 100 mol % from a viewpoint of adhesive property.

A polyvinyl alcohol-based resin having an acetoacetyl group may be used as the above-mentioned polyvinyl alcohol-based resin. The polyvinyl alcohol-based resin having an acetoacetyl group is a polyvinyl alcohol-based adhesive having a highly reactive functional group and is preferred from the viewpoint of improving durability of an optical film to be obtained.

The polyvinyl alcohol-based resin having an acetoacetyl group is obtained in a reaction between the polyvinyl alcohol-based resin and diketene through a known method. Examples of the known method include: a method involving dispersing the polyvinyl alcohol-based resin in a solvent such as acetic acid, and adding diketene thereto; and a method involving dissolving the polyvinyl alcohol-based resin in a solvent such as dimethylformamide or dioxane, in advance, and adding diketene thereto. Another example of the known method is a method involving directly bringing diketene gas or a liquid diketene into contact with polyvinyl alcohol.

A degree of acetoacetyl modification of the polyvinyl alcohol-based resin having an acetoacetyl group is not particularly limited as long as it is 0.1 mol % or more. A degree of acetoacetyl modification of less than 0.1 mol % provides insufficient water resistance with the adhesive layer and is inappropriate. The degree of acetoacetyl modification is preferably 0.1 to 40 mol %, and more preferably 1 to 20 mol %. A degree of acetoacetyl modification of more than 40 mol % decreases the number of reaction sites with a crosslinking agent and provides a small effect of improving the water resistance. The degree of acetoacetyl modification is a value measured by NMR.

A crosslinking agent used for the polyvinyl alcohol-based adhesive may be used as the above-mentioned crosslinking agent without particular limitation.

A compound having at least two functional groups each having reactivity with a polyvinyl alcohol-based resin can be used as the crosslinking agent. Examples of the compound include: alkylene diamines having an alkylene group and two amino groups such as ethylene diamine, triethylene amine, and hexamethylene dimamine (of those, hexamethylene diamine is preferred); isocyanates such as tolylene diisocyanate, hydrogenated tolylene diisocyanate, a trimethylene propane tolylene diisocyanate adduct, triphenylmethane triisocyanate, methylene bis(4-phenylmethane)triisocyanate, isophorone diisocyanate, and ketoxime blocked compounds and phenol blocked compounds thereof; epoxies such as ethylene glycol diglycidyl ether, polyethylene glycol diglycidyl ether, glycerin di- or triglycidyl ether, 1,6-hexane diol diglycidyl ether, trimethylol propane triglycidyl ether, diglycidyl aniline, and diglycidyl amine; monoaldehydes such as formaldehyde, acetaldehyde, propione aldehyde, and butyl aldehyde; dialdehydes such as glyoxal, malondialdehyde, succinedialdehyde, glutardialdehyde, maleic dialdehyde, and phthaldialdehyde; an amino/formaldehyde resin such as a condensate of formaldehyde with methylolurea, methylolmelamine, alkylated methylolurea, alkylated methylol melamine, acetoguanamine, or benzoguanamine; and salts of divalent metals or trivalent metals such as sodium, potassium, magnesium, calcium, aluminum, iron, and nickel and oxides thereof. A melamine-based crosslinking agent is preferred as the crosslinking agent, and methylolmelamine is particularly preferred.

A mixing amount of the crosslinking agent is preferably 0.1 to 35 parts by weight, and more preferably 10 to 25 parts by weight with respect to 100 parts by weight of the polyvinyl alcohol-based resin. Meanwhile, for improving the durability, the crosslinking agent may be mixed within a range of more than 30 parts by weight and 46 parts by weight or less with respect to 100 parts by weight of the polyvinyl alcohol-based resin. In particular, in the case where the polyvinyl alcohol-based resin having an acetoacetyl group is used, the crosslinking agent is preferably used in an amount of more than 30 parts by weight. The crosslinking agent is mixed within a range of more than 30 parts by weight and 46 parts by weight or less, to thereby improve the water resistance.

Note that the above-mentioned polyvinyl alcohol-based adhesive may further contain a coupling agent such as a silane coupling agent or a titanium coupling agent; various tackifiers; a UV absorber; an antioxidant; and a stabilizer such as a heat resistant stabilizer or a hydrolysis resistant stabilizer.

A surface in contact with the polarizer (preferably, the above-mentioned transparent protective film surface or a protective film surface on the other surface side) may be subjected to easily adhesive treatment for improving adhesive property. Examples of the easily adhesive treatment include corona treatment, plasma treatment, low-pressure UV treatment, surface treatment such as saponification treatment, and a method of forming an anchor layer, and those may be used in combination. Of those, corona treatment, a method of forming an anchor layer, and a method of combining the corona treatment and the method of forming an anchor layer are preferred.

An example of the anchor layer is a silicone layer having a reactive functional group. A material for the silicone layer having a reactive functional group is not particularly limited. However, examples thereof include isocyanate group-containing alkoxy silanols; amino group-containing alkoxy silanols; mercapto group-containing alkoxy silanols; carboxy group-containing alkoxy silanols; epoxy group-containing alkoxy silanols; vinyl unsaturated group-containing alkoxy silanols; halogen group-containing alkoxy silanols; and isocyanate group-containing alkoxy silanols. Amino-based silanols are preferred. A titanium-based catalyst or a tin-based catalyst for effectively reacting the silanols may be added, to thereby enhance the adhesive strength. The silicone having a reactive functional group may contain other additives added. Specific examples thereof that may be used include: a tackifier formed of a terpene resin, a phenol resin, a terpene/phenol resin, a rosin resin, a xylene resin, or the like; a UV absorber; an antioxidant; and a stabilizer such as a heat resistant stabilizer.

The silicone layer having a reactive functional group is formed by applying and drying through a known method. The silicone layer has a thickness of preferably 1 to 100 nm, and more preferably 10 to 50 nm after drying. For application, silicone having a reactive functional group may be diluted with a solvent. A diluting solvent is not particularly limited, but examples thereof include alcohols. A dilution concentration is not particularly limited, but is preferably 1 to 5 wt %, and more preferably 1 to 3 wt %.

The adhesive layer is preferably formed by applying the adhesive to one or to both of the surfaces of the protective film and the polarizer. After the protective film and the polarizer are attached together, the whole is preferably subjected to a drying step to form an adhesive layer formed of an applied and dried layer. The adhesive layer may be formed and then attached. The attachment may be performed by using a roll laminator or the like. A heat drying temperature and a drying time may arbitrarily be determined in accordance with the type of adhesive.

According to the production method of the present invention, the slow axis of the first compensation layer may be set through the alignment treatment of the protective film, and thus a continuous polarizing film (polarizer) stretched in a longitudinal direction (that is, having an absorption axis in a longitudinal direction) can be used. That is, the continuous protective film subjected to alignment treatment for forming a predetermined angle with respect to the longitudinal direction and the continuous polarizing film (polarizer) may be continuously attached together while the respective longitudinal directions are in the same direction (by so-called roll to roll). Thus, an optical film can be obtained at excellent production efficiency. Further, according to this method, the film needs not be cut out in an oblique direction with respect to the longitudinal direction (stretching direction) for lamination. Thus, angles of optical axes of cut out films will not vary. As a result, an optical film without varying quality by product can be obtained. Further, no waste by cutting is produced, and thus an optical film can be obtained at low cost. In addition, production of a polarizing plate is facilitated.

Note that the direction of the absorption axis of the polarizer is substantially parallel to the longitudinal direction of the continuous film. In the specification of the present invention, the phrase “substantially parallel” includes the case where an angle formed between the longitudinal direction and the direction of the absorption axis is 0°±10°, preferably 0°±5°, and more preferably 0°±3°.

B-4-2. Case where First Optical Compensation Layer Formed on Substrate is Transferred and Substrate is Eventually Peeled Off

The first optical compensation layer formed on the substrate is transferred to the surface of the transparent protective film. The transparent protective film is different from the substrate, and specific examples thereof include films described above as the substrates to be used as the polarizer protective film in the present invention. Preferably, a triacetyl cellulose (TAC) film is used. A transfer method is not particularly limited, and an example thereof involves attaching the first optical compensation layer supported on the substrate to the protective film through an adhesive. The transfer method is employed, to thereby provide an optical film having excellent adhesiveness between films (layers) at excellent production efficiency.

A typical example of the adhesive is a curable adhesive. Typical examples of the curable adhesive include: a photo-curable adhesive such as a UV-curable adhesive; a moisture-curable adhesive; and a thermosetting adhesive. A specific example of the thermosetting adhesive is a thermosetting resin-based adhesive formed of an epoxy resin, an isocyanate resin, a polyimide resin, or the like. A specific example of the moisture-curable adhesive is an isocyanate resin-based moisture-curable adhesive. The moisture-curable adhesive (in particular, an isocyanate resin-based moisture-curable adhesive) is preferred. The moisture-curable adhesive cures through a reaction with moisture in air, water adsorbed on a surface of an adherend, a hydroxyl group, an active hydrogen group of a carboxyl group or the like, etc. Thus, the adhesive may be applied and then cured naturally by leaving at stand, and has excellent operability. Further, the moisture-curable adhesive requires no heating for curing, and thus the first optical compensation layer and the protective layer are not heated during lamination (bonding). As a result, no heat shrinkage occurs, and thus formation of cracks during lamination or the like may significantly be prevented even in the case where the first optical compensation layer and the protective film each have an extremely small thickness as in the present invention. Note that the isocyanate resin-based adhesive is a general term for a polyisocyanate-based adhesive and a polyurethane resin adhesive.

For example, a commercially available adhesive may be used as the curable adhesive, or various curable resins may be dissolved or dispersed in a solvent to prepare a curable resin adhesive solution (or dispersion). In the case where the solution (or dispersion) is prepared, a ratio of the curable resin in the solution is preferably 10 to 80 wt %, more preferably 20 to 65%, especially preferably 25 to 65 wt %, and most preferably 30 to 50 wt % in solid content. Any appropriate solvent may be used as the solvent to be used in accordance with the type of curable resin, and specific examples thereof include ethyl acetate, methyl ethyl ketone, methyl isobutyl ketone, toluene, and xylene. One type of solvent may be used alone, or two or more types thereof may be used in combination.

An application amount of the adhesive may appropriately be set in accordance with the purpose. For example, the application amount is preferably 0.3 to 3 ml, more preferably 0.5 to 2 ml, and most preferably 1 to 2 ml per area (cm²) of the first optical compensation layer or the protective film. After the application, the solvent in the adhesive is evaporated through natural drying or heat drying as required. A thickness of the adhesive layer to be obtained is preferably 0.1 to 20 μm, more preferably 0.5 to 15 μm, and most preferably 1 to 10 μm. A Microhardness of the adhesive layer is preferably 0.1 to 0.5 GPa, more preferably 0.2 to 0.5 GPa, and most preferably 0.3 to 0.4 GPa. Correlation between Microhardness and Vickers hardness is known, and thus the Microhardness may be converted into Vickers hardness. The Microhardness may be calculated from indentation depth and indentation load by using a thin-film hardness meter (trade names, MH4000 and MHA-400, for example, manufactured by NEC Corporation).

Next, the substrate is peeled off from the first optical compensation layer, to thereby complete lamination of the first optical compensation layer and the protective film.

Meanwhile, the polarizer is laminated on the protective film on a surface opposite to the first optical compensation layer. The lamination of the polarizer may be conducted at any appropriate time in the production method of the present invention. For example, the polarizer may be laminated on the protective film in advance, or the polarizer may be laminated after the first optical compensation layer is formed. Alternatively, the polarizer may be laminated after the second optical compensation layer is formed. For example, a polarizing plate (protective film/polarizer/protective film) may be produced in advance, and then the first optical compensation layer may be formed through transfer.

Any appropriate lamination method (bonding, for example) may be employed as the method of laminating the protective film and the polarizer. The bonding may be performed by using any appropriate adhesive or pressure-sensitive adhesive. The type of adhesive or pressure-sensitive adhesive may arbitrarily selected in accordance with the type of adherend (that is, the protective film and the polarizer). Specific examples of the adhesive include: polymer adhesives such as an acrylic adhesive, a vinyl alcohol-based adhesive, a silicone-based adhesive, a polyester-based adhesive, a polyurethane-based adhesive, and a polyether-based adhesive; isocyanate-based adhesives; and rubber-based adhesives. Specific examples of the pressure-sensitive adhesive include an acrylic pressure-sensitive adhesive, a vinyl alcohol-based pressure-sensitive adhesive, a silicone-based pressure-sensitive adhesive, a polyester-based pressure-sensitive adhesive, a polyurethane-based pressure-sensitive adhesive, a polyether-based pressure-sensitive adhesive, an isocyanate-based pressure-sensitive adhesive, and a rubber-based pressure-sensitive adhesive.

The thickness of the adhesive or pressure-sensitive adhesive is not particularly limited, but is preferably 10 to 200 nm, more preferably 15 to 180 nm, and most preferably 20 to 150 nm.

According to the production method of the present invention, the slow axis of the first compensation layer may be set through the alignment treatment of the protective film, and thus a continuous polarizing film (polarizer) stretched in a longitudinal direction (that is, having an absorption axis in a longitudinal direction) can be used. That is, the continuous protective film subjected to alignment treatment for forming a predetermined angle with respect to the longitudinal direction and the continuous polarizing film (polarizer) may be continuously attached together while the respective longitudinal directions are in the same direction (by so-called roll to roll). Thus, an optical film can be obtained at excellent production efficiency. Further, according to this method, the film needs not be cut out in an oblique direction with respect to the longitudinal direction (stretching direction) for lamination. Thus, angles of optical axes of cut out films will not vary. As a result, an optical film without varying quality by product can be obtained. Further, no waste by cutting is produced, and thus an optical film can be obtained at low cost. In addition, production of a polarizing plate is facilitated.

Note that the direction of the absorption axis of the polarizer is substantially parallel to the longitudinal direction of the continuous film. In the specification of the present invention, the phrase “substantially parallel” includes the case where an angle formed between the longitudinal direction and the direction of the absorption axis is 0°±10°, preferably 0°±5°, and more preferably 0°±3°.

### B-5. Step of Forming Second Optical Compensation Layer

The second optical compensation layer is formed on the surface of the first optical compensation layer. Typically, the second optical compensation layer is formed by laminating the polymer film described in the above section A-3 on the surface of the first optical compensation layer. Preferably, the polymer film is a stretched film. A lamination method is not particularly limited, and the lamination is conducted by using any appropriate adhesive or pressure-sensitive adhesive (such as the adhesive or pressure-sensitive adhesive described above).

A typical example of the adhesive or pressure-sensitive adhesive is a curable adhesive. Typical examples of the curable adhesive include: a photo-curable adhesive such as a UV-curable adhesive; a moisture-curable adhesive; and a thermosetting adhesive. A specific example of the thermosetting adhesive is a thermosetting resin-based adhesive formed of an epoxy resin, an isocyanate resin, a polyimide resin, or the like. A specific example of the moisture-curable adhesive is an isocyanate resin-based moisture-curable adhesive. The moisture-curable adhesive (in particular, an isocyanate resin-based moisture-curable adhesive) is preferred. The moisture-curable adhesive cures through a reaction with moisture in air, water adsorbed on a surface of an adhered, a hydroxyl group, an active hydrogen group of a carboxyl group or the like, etc. Thus, the adhesive may be applied and then cured naturally by leaving at stand, and has excellent operability. Further, the moisture-curable adhesive requires no heating for curing, and thus the first optical compensation layer and the second optical compensation layer are not heated during lamination (bonding). As a result, no heat shrinkage occurs, and thus formation of cracks during lamination or the like may significantly be prevented even in the case where the first optical compensation layer and the protective film each layer has an extremely small thickness as in the present invention. Note that the isocyanate resin-based adhesive is a general term for a polyisocyanate-based adhesive and a polyurethane resin adhesive.

For example, a commercially available adhesive may be used as the curable adhesive, or various curable resins may be dissolved or dispersed in a solvent to prepare a curable resin adhesive solution (or dispersion). In the case where the solution (or dispersion) is prepared, a ratio of the curable resin in the solution is preferably 10 to 80 wt %, more preferably 20 to 65%, especially preferably 25 to 65 wt %, and most preferably 30 to 50 wt % in solid content. Any appropriate solvent may be used as the solvent to be used in accordance with the type of curable resin, and specific examples thereof include ethyl acetate, methyl ethyl ketone, methyl isobutyl ketone, toluene, and xylene. One type of solvent may be used alone, or two or more types thereof may be used in combination.

An application amount of the adhesive may appropriately be set in accordance with the purpose. For example, the application amount is preferably 0.3 to 3 ml, more preferably 0.5 to 2 ml, and most preferably 1 to 2 ml per area (cm²) of an application object. After the application, the solvent in the adhesive is evaporated through natural drying or heat drying as required. A thickness of the adhesive layer to be obtained is preferably 0.1 to 20 μm, more preferably 0.5 to 15 μm, and most preferably 1 to 10 μm. A Microhardness of the adhesive layer is preferably 0.1 to 0.5 GPa, more preferably 0.2 to 0.5 GPa, and most preferably 0.3 to 0.4 GPa. Correlation between Microhardness and Vickers hardness is known, and thus the Microhardness may be converted into Vickers hardness. The Microhardness may be calculated from indentation depth and indentation load by using a thin-film hardness meter (trade names, MH4000 and MHA-400, for example, manufactured by NEC Corporation).

B-6. Production of Polarizing Plate Provided with Optical Compensation Layers

Referring to FIGS. 6 and 7, description will be given of an example of a specific procedure for producing the polarizing plate provided with optical compensation layers of the present invention. Note that in FIGS. 6 and 7, reference numerals 111 and 112 represent rolls used for rolling films forming each layer and/or a laminate.

A continuous polymer film as a raw material for a polarizer is prepared, and the continuous polymer film is colored, stretched, and the like as described in the above section A-4. The stretching is conducted continuously on the continuous polymer film in a longitudinal direction. In this way, as shown by a perspective view of FIG. 6, a continuous polarizer 11 having an absorption axis in a longitudinal direction (stretching direction: direction of an arrow) is obtained.

As shown by a perspective view of FIG. 7(a), a continuous substrate 13 is prepared, and a surface thereof is subjected to rubbing treatment with rubbing rolls 120 and 120′. A direction of the rubbing is in a different direction from a longitudinal direction of the substrate 13, for example, in a direction of ±23° and a direction of −23°. Next, as shown by a perspective view of FIG. 7(b), the first optical compensation layer (B) 30 and the first optical compensation layer (B′) 30′ are formed on the substrate 13 subjected to the rubbing treatment as described in the above sections B-2 and B-3. In the first optical compensation layer (B) 30 and the first optical compensation layer (B′) 30′, a liquid crystal material aligns along the rubbing direction, and thus a slow axis direction is in substantially the same direction as the rubbing direction of the substrate 13.

As described above, the first optical compensation layer (B) 30 and the first optical compensation layer (B′) 30′ are formed on the substrate 13 formed of single original sheet. From this laminated film, a part in which the first optical compensation layer (B) 30 is laminated and a part in which the first optical compensation layer (B′) 30′ is laminated are punched out, to thereby produce a laminate of substrate 13/first optical compensation layer (B) 30 and a laminate of substrate 13/first optical compensation layer (B′) 30′.

In the case where the substrate 13 of the laminate produced as described above is a protective film and serves as a polarizer protective film, that is, in the case where the substrate 13 is the protective film 12, for examples, the second optical compensation layer (C) 40 is laminated on the first optical compensation layer (B) 30 in the laminate of protective film 12/first optical compensation layer (B) 30 through any appropriate adhesive or pressure-sensitive adhesive described in the above section B-5. Similarly, the second optical compensation layer (C′) 40′ is laminated on the first optical compensation layer (B′) 30′ in the laminate of protective film 12/first optical compensation layer (B′) 30′ through any appropriate adhesive or pressure-sensitive adhesive described in the above section B-5. The polarizer 11 and the protective film 15 are laminated on a protective film 12 side of the laminate of protective film 12/first optical compensation layer (B) 30/second optical compensation layer (C) 40, to thereby produce the polarizing plate provided with optical compensation layers 500 (second optical compensation layer (C) 40/first optical compensation layer (B) 30/protective film 12/polarizer 11/protective film 15). Note that the polarizer 11 or the protective film 15 may be laminated on the protective film 12 at any time, and the polarizer 11 or the protective film 15 may be laminated on the protective film 12 in advance before the alignment treatment of the protective film 12. Similarly, the polarizing plate provided with optical compensation layers 500′ (second optical compensation layer (C′) 40′/first optical compensation layer (B′) 30′/protective film 12/polarizer 11/protective film 15) is produced.

In the case where the first optical compensation layer formed on the substrate 13 is transferred, and the substrate 13 is eventually peeled off, as shown in a schematic diagram of FIG. 8(a), the protective film 15, the polarizer 11, the protective film 12, and a laminate 121 of substrate 13/first optical compensation layer (B) 30 are delivered in a direction of an arrow and are attached together through an adhesive or the like (not shown) while respective longitudinal directions are in the same direction, to thereby form the a laminate 123′. Further, as shown in FIG. 8(b), the substrate 13 is peeled off from the laminate 123′, to thereby form a laminate 123 (protective film 15, polarizer 11, protective film 12, and first optical compensation layer (B) 30). As shown in a schematic diagram of FIG. 9, the second optical compensation layer (C) 40 is prepared. The second optical compensation layer (C) 40 and the laminate 123 (protective film 15, polarizer 11, protective film 12, and first optical compensation layer (B) 30) are delivered in a direction of an arrow and are attached together through an adhesive or the like (not shown) while respective longitudinal directions are in the same direction. In this way, the polarizing plate provided with optical compensation layers 500 (second optical compensation layer (C) 40/first optical compensation layer (B) 30/protective film 12/polarizer 11/protective film 15) is produced. Similarly, the polarizing plate provided with optical compensation layers 500′ (second optical compensation layer (C′) 40′/first optical compensation layer (B′) 30′/protective film 12/polarizer 11/protective film 15) is produced. Note that in FIGS. 8 and 9, reference numeral 122 represents guide rolls for attaching the films together, and reference numerals 113 to 118 each represent a roll used for rolling films forming each layer and/or a laminate.

B-7. Applications of Polarizing Plate Provided with Optical Compensation Layers

The polarizing plate provided with optical compensation layers of the present invention may preferably be used for various image display apparatuses (such as a liquid crystal display apparatus and a self-luminous display apparatus). Specific examples of the image display apparatus to be applied to include a liquid crystal display apparatus, an EL display, a plasma display (PD), and a field emission display (FED). The polarizing plate provided with optical compensation layers of the present invention to be used for a liquid crystal display apparatus is useful for prevention of light leak in dark display and for viewing angle compensation, for example. The polarizing plate provided with optical compensation layers of the present invention is preferably used for a liquid crystal display apparatus of VA mode, and is particularly preferably used for a reflective or semi-transmissive liquid crystal display apparatus of VA mode. The polarizing plate provided with optical compensation layers of the present invention to be used for an EL display is useful for prevention of electrode reflection, for example.

### B-8. Production of Liquid Crystal Panel

The second optical compensation layer (C) 40 side of the thus-obtained polarizing plate provided with optical compensation layers 500 and the second optical compensation layer (C′) 40′ side of the polarizing plate provided with optical compensation layers 500′ are attached to both surfaces of the liquid crystal cell such that the absorption axis of the polarizer 11 in the polarizing plate provided with optical compensation layers 500 and the absorption axis of the polarizer 11′ in the polarizing plate provided with optical compensation layers 500′ are perpendicular to each other, to thereby provide the liquid crystal panel as shown in FIG. 1.

Any appropriate drive mode can be employed for drive mode of the liquid crystal cell as long as effects of the present invention can be obtained. Specific examples of the drive mode include STN (Super Twisted Nematic) mode, TN (Twisted Nematic) mode, IPS (In-Plane Switching) mode, VA (Vertical Aligned) mode, OCB (OpticallyAlignedBirefringence) mode, HAN (HybridAlignedNematic) mode, and ASM (Axially Symmetric Aligned Microcell) mode. The VA mode and the OCB mode are preferred. For example, remarkable improvements in color shifts can be obtained by combining the first optical compensation layer and the second optical compensation layer.

### EXAMPLES

Hereinafter, the present invention will be described more specifically by way of examples, but the present invention is not limited thereto.

### (1) Measurement of Retardation

Refractive indices nx, ny, and nz of a sample film were measured with an automatic birefringence analyzer (Automatic birefringence analyzer KOBRA31PR manufactured by Oji Scientific Instruments), and an in-plane retardation Re and a thickness retardation Rth were calculated. A measurement temperature was 23° C., and a measurement wavelength was 590 nm.

### (2) Measurement of Thickness

The thickness of the first optical compensation layer was measured by a coherent film thickness measurement method by using MCPD2000 (manufactured by Otsuka Electronics Co., Ltd). The thickness of each of other various films was measured by using a dial gauge.

### (3) Measurement of Contrast

The contrast of the obtained liquid crystal panel in dark display was measured. “EZ-Contrast 160D” (manufactured by ELDIM SA) was used for the measurement.

### Examples 1 to 3

### a. Production of Polarizing Plate Formed of TAC/Polarizer/TAC

A polyvinyl alcohol film was colored in an aqueous solution containing iodine, and the resultant was uniaxially stretched to a six times length between rolls with different speed ratios in an aqueous solution containing boric acid, to thereby produce a polarizer. This polarizer and TAC films (thickness of 40 μm) were attached together in the order of TAC/polarizer/TAC by using an adhesive such that an absorption axis direction of the polarizer was in a longitudinal direction, to thereby obtain a polarizing plate.

### b. Alignment Treatment

One TAC film surface of the polarizing plate obtained above was subjected to rubbing on single original sheet (total length of 3,000 m and a total width of 500 mm) by using a rubbing roll at a rubbing angle of about +23° and about −23° as shown in FIG. 7(a).

### c. Formation of First Optical Compensation Layer

10 g of polymerizable liquid crystals exhibiting a nematic liquid crystal phase (Paliocolor LC242, trade name, available from BASE Aktiengesellschaft), and 0.5 g of a photopolymerization initiator for the polymerizable liquid crystal compound (Irgacure 907, trade name, available from Ciba Specialty Chemicals) were dissolved in 40 g of toluene, to thereby prepare a liquid crystal composition (application liquid). The application liquid was applied to the surface of the thus-produced polarizing plate (1) subjected to the alignment treatment by using a bar coater, and the whole was dried under heating at 90° C. for 2 minutes, to thereby align the liquid crystals. The thus-formed liquid crystal layer was irradiated with light of 20 mJ/cm² by using a metal halide lamp, and the liquid crystal layer was cured, to thereby form a first optical compensation layer having refractive index profile of nx>ny=nz. A first optical compensation layer (1A) was formed on the surface subjected to the alignment treatment at a +angle, and a first optical compensation layer (1B) was formed on the surface subjected to the alignment treatment at a −angle. From the obtained laminate, a part in which the first optical compensation layer (1A) was formed and a part in which the first optical compensation layer (1B) was formed were punched out. The first optical compensation layer (1A) and the first optical compensation layer (1B) each had a thickness of 2 μm. Table 1 shows an in-plane retardation of the first optical compensation layer (1A), an in-plane retardation of the first optical compensation layer (1B), and a difference therebetween.

### d. Formation of Second Optical Compensation Layer

A norbornene-based film (“Zeonor”, trade name, available from Zeon Corporation, thickness before stretching of 60 μm) was biaxially stretched 1.25 times in an X-axis direction and 1.03 times in a Y-axis direction at 135° C., to thereby obtain a second optical compensation layer (thickness after stretching of 40 μm). Retardations of the second optical compensation layer were measured by using KOBRA21ADH (manufactured by Oji Scientific Instruments), resulting in an in-plane retardation of 120 nm, a thickness direction retardation of 192 nm, and an Nz coefficient of 1.6.

### e. Production of Polarizing Plate Provided with Optical Compensation Layers

To the surface of the first optical compensation layer (1A) of the laminate of first optical compensation layer (1A)/polarizing plate obtained as described above, the second optical compensation layer was attached by using an isocyanate-based adhesive, to thereby obtain a polarizing plate provided with optical compensation layers (A) having a structure of second optical compensation layer/first optical compensation layer (1A)/polarizing plate. To the surface of the first optical compensation layer (1B) of the laminate of first optical compensation layer (1B)/polarizing plate obtained as described above, the second optical compensation layer was attached by using an isocyanate-based adhesive, to thereby obtain a polarizing plate provided with optical compensation layers (B) having a structure of second optical compensation layer/first optical compensation layer (1B)/polarizing plate.

### f. Production of Liquid Crystal Panel

To a viewer side of a liquid crystal cell (taken out of Play Station Portable (PSP), manufactured by Sony Corporation), the polarizing plate provided with optical compensation layers (B) was attached through an acrylic pressure-sensitive adhesive (thickness of 20 μm) such that the polarizing plate was positioned on an outer side (on the viewer side). To a backlight side of the liquid crystal cell, the polarizing plate provided with optical compensation layers (A) was attached through an acrylic pressure-sensitive adhesive (thickness of 20 μm) such that the polarizing plate was positioned on an outer side (on the backlight side). In this arrangement, an absorption axis of the polarizer in the polarizing plate provided with optical compensation layers (A) and an absorption axis of the polarizer in the polarizing plate provided with optical compensation layers (B) were perpendicular to each other.

### g. Evaluation

The contrast of the obtained liquid crystal panel was measured. Table 1 shows the results.

### Examples 4 to 6

### a. Alignment Treatment of Substrate

A surface of a polyethylene terephthalate (PET) film (Lumirror R41, available from Toray Industries, Inc., thickness of 50 μm) was subjected to rubbing on single original sheet (total length of 3,000 m and a total width of 500 mm) by using a rubbing roll at a rubbing angle of about +23° and about −23° as shown in FIG. 7(a).

### b. Formation of First Optical Compensation Layer

10 g of polymerizable liquid crystals exhibiting a nematic liquid crystal phase (Paliocolor LC242, trade name, available from BASF Aktiengesellschaft), and 0.5 g of a photopolymerization initiator for the polymerizable liquid crystal compound (Irgacure 907, trade name, available from Ciba Specialty Chemicals) were dissolved in 40 g of toluene, to thereby prepare a liquid crystal composition (application liquid). The application liquid was applied to the surface of the thus-produced PET substrate subjected to the alignment treatment by using a bar coater, and the whole was dried under heating at 90° C. for 2 minutes, to thereby align the liquid crystals. The thus-formed liquid crystal layer was irradiated with light of 20 mJ/cm² by using a metal halide lamp, and the liquid crystal layer was cured, to thereby form a first optical compensation layer having refractive index profile of nx>ny=nz. A first optical compensation layer (1A) was formed on the surface subjected to the alignment treatment at a +angle, and a first optical compensation layer (1B) was formed on the surface subjected to the alignment treatment at a −angle. From the obtained laminate, a part in which the first optical compensation layer (1A) was formed and a part in which the first optical compensation layer (1B) was formed were punched out. The first optical compensation layer (1A) and the first optical compensation layer (1B) each had a thickness of 2 μm. Table 1 shows an in-plane retardation of the first optical compensation layer (1A), an in-plane retardation of the first optical compensation layer (1B), and a difference therebetween.

### c. Production of Polarizer

A polyvinyl alcohol film was colored in an aqueous solution containing iodine, and the resultant was uniaxially stretched to a six times length between rolls with different speed ratios in an aqueous solution containing boric acid, to thereby produce a polarizer.

### d. Formation of Second Optical Compensation Layer

A norbornene-based film (“Zeonor”, trade name, available from Zeon Corporation, thickness before stretching of 60 μm) was biaxially stretched 1.25 times in an X-axis direction and 1.03 times in a Y-axis direction at 135° C., to thereby obtain a second optical compensation layer (thickness after stretching of 40 μm). Retardations of the second optical compensation layer were measured by using KOBRA21ADH (manufactured by Oji Scientific Instruments), resulting in an in-plane retardation of 120 nm, a thickness direction retardation of 192 nm, and an Nz coefficient of 1.6.

### e. Production of Polarizing Plate Provided with Optical Compensation Layers

A TAC film (thickness of 40 μm), the polarizer obtained in the above section c, a TAC film (thickness of 40 μm), and the laminate of first optical compensation layer (1A)/PET substrate obtained in the above section b were laminated as shown in FIG. 8(a), and then the PET substrate was peeled off as shown in FIG. 8(b), to thereby obtain a laminate of TAC/polarizer/TAC/first optical compensation layer (1A). Further, this laminate and the second optical compensation layer obtained in the above section d were laminated as shown in FIG. 9 by using an isocyanate-based adhesive, to thereby obtain a polarizing plate provided with optical compensation layers (A) having a structure of second optical compensation layer/first optical compensation layer (1A)/TAC/polarizer/TAC. Similarly, a TAC film (thickness of 40 μm), the polarizer obtained in the above section c, a TAC film (thickness of 40 μm), and the laminate of first optical compensation layer (1B)/PET substrate obtained in the above section b were laminated as shown in FIG. 8(a), and then the PET substrate was peeled off as shown in FIG. 8(b), to thereby obtain a laminate of TAC/polarizer/TAC/first optical compensation layer (1B). Further, this laminate and the second optical compensation layer obtained in the above section d were laminated as shown in FIG. 9 by using an isocyanate-based adhesive, to thereby obtain a polarizing plate provided with optical compensation layers (B) having a structure of second optical compensation layer/first optical compensation layer (1B)/TAC/polarizer/TAC.

### f. Production of Liquid Crystal Panel

To a viewer side of a liquid crystal cell (taken out of Play Station Portable (PSP), manufactured by Sony Corporation) the polarizing plate provided with optical compensation layers (B) was attached through an acrylic pressure-sensitive adhesive (thickness of 20 μm) such that the polarizing plate was positioned on an outer side (on the viewer side). To a backlight side of the liquid crystal cell, the polarizing plate provided with optical compensation layers (A) was attached through an acrylic pressure-sensitive adhesive (thickness of 20 μm) such that the polarizing plate was positioned on an outer side (on the backlight side). In this arrangement, an absorption axis of the polarizer in the polarizing plate provided with optical compensation layers (A) and an absorption axis of the polarizer in the polarizing plate provided with optical compensation layers (B) were perpendicular to each other.

### g. Evaluation

The contrast of the obtained liquid crystal panel was measured. Table 1 shows the results.

### Comparative Examples 1 to 3

In the above section b of each of Examples 1 to 3, one TAC film surface of the polarizing plate obtained by following the procedure in the above section a was subjected to rubbing by using a rubbing roll at a rubbing angle of about +23°. Another TAC film surface of the polarizing plate obtained by following the procedure in the above section a was subjected to rubbing by using a rubbing roll at a rubbing angle of about −23°.

Similar to the above section c of each of Examples 1 to 3, a first optical compensation layer (1C) was formed on the surface of the polarizing plate subjected to the alignment treatment at a +angle, and a first optical compensation layer (1D) was formed on the surface of the polarizing plate subjected to the alignment treatment at a −angle. The first optical compensation layer (1C) and the first optical compensation layer (1D) each had a thickness of 2 μm. Table 1 shows the in-plane retardation of the first optical compensation layer (1C), the in-plane retardation of the first optical compensation layer (1D), and the difference therebetween. A liquid crystal panel was obtained in the same manner as in the above sections d, e, and f of each of Examples 1 to 3. The contrast of the obtained liquid crystal panel was measured. Table 1 shows the results.

### Comparative Examples 4 to 6

In the above section a of each of Examples 4 to 6, a surface of a polyethylene terephthalate (PET) film was subjected to rubbing by using a rubbing roll at a rubbing angle of about +23°. A surface of a polyethylene terephthalate (PET) film prepared separately was subjected to rubbing by using a rubbing roll at a rubbing angle of about −23°.

Similar to the above section b of each of Examples 4 to 6, a first optical compensation layer (1C) was formed on the surface of the PET substrate subjected to the alignment treatment at a +angle, and a first optical compensation layer (1D) was formed on the surface of the PET substrate subjected to the alignment treatment at a −angle. The first optical compensation layer (1C) and the first optical compensation layer (1D) each had a thickness of 2 μm. Table 1 shows the in-plane retardation of the first optical compensation layer (1C), the in-plane retardation of the first optical compensation layer (1D), and the difference therebetween.

A liquid crystal panel was obtained in the same manner as in the above sections c, d, e, and f of each of Examples 4 to 6. The contrast of the obtained liquid crystal panel was measured. Table 1 shows the results.

TABLE 1

| | In-plane | In-plane | | |
|---|---|---|---|---|
| | retardation of | retardation of | | |
| | first optical | first optical | | |
| | compensation | compensation | Difference | |
| | layer on + | layer on − | between X | |
| | alignment angle | alignment angle | and Y | |
| | (X) (nm) | (Y) (nm) | (nm) | Contrast |
| Example | 249.2 | 249.9 | 0.7 | 295.8 |
| 1 | | | | |
| Example | 252.2 | 253.5 | 1.3 | 293.3 |
| 2 | | | | |
| Example | 251.6 | 253.3 | 1.7 | 300.5 |
| 3 | | | | |
| Example | 244.6 | 245.2 | 0.6 | 305.4 |
| 4 | | | | |
| Example | 253.8 | 252.7 | 1.1 | 298.2 |
| 5 | | | | |
| Example | 252.0 | 250.5 | 1.5 | 294.6 |
| 6 | | | | |
| Comparative | 258.3 | 250.7 | 7.6 | 256.5 |
| example 1 | | | | |
| Comparative | 244.3 | 253.5 | 9.2 | 232.6 |
| example 2 | | | | |
| Comparative | 253.9 | 241.9 | 12.0 | 240.6 |
| example 3 | | | | |
| Comparative | 249.9 | 241.7 | 8.2 | 249.8 |
| example 4 | | | | |
| Comparative | 256.2 | 246.7 | 9.5 | 245.3 |
| example 5 | | | | |
| Comparative | 253.3 | 241.6 | 11.7 | 235.5 |
| example 6 | | | | |

In Examples 1 to 6, the substrates (TAC film in Examples 1 to 3 and PET film in Examples 4 to 6) used for the polarizing plates provided with optical compensation layers (A) and (B) arranged above and below the liquid crystal cell are derived from single original sheet. Thus, variation in thickness of the substrate by production lot is reduced, and precision in thickness increases. Further, variation in surface state or surface energy of the substrate by production lot is reduced, and thus shift in retardation can be reduced.

In Examples 1 to 6, the application liquid of the same lot can be used as the application liquid used for forming the polarizing plates provided with optical compensation layers (A) and (B) arranged above and below the liquid crystal cell. In general, the application liquid contains a liquid crystal material, one type of solvent or two or more types of solvents, and a polymerization initiator, for example. In this way, the application liquid generally contains a polymerization initiator. Thus, a prepared application liquid undergoes a relatively rapid chemical reaction and increases in viscosity. Further, application may involve difficulties, and desired properties may not be obtained. In the case where the first optical compensation layers are formed on separate substrates as in Comparative Examples 1 to 6, application liquids of different lots prepared for respective cases must be used. Meanwhile, use of the application liquid of the same lot as in Examples 1 to 6 eliminates nonuniformity due to properties (a molecular weight distribution, an amount of impurities, and the like) of the liquid crystal material by production lot, and as a result, shift in retardation can be reduced. Use of the application liquid of the same lot as in Examples 1 to 6 eliminates nonuniformity due to the concentration or composition ratio of the application liquid to be used. As a result, shift in retardation can be reduced.

In Examples 1 to 6, the application of the application liquid used for forming the polarizing plates provided with optical compensation layers (A) and (B) arranged above and below the liquid crystal cell may be conducted substantially simultaneously. Thus, variation in temperature during application of the application liquid can be reduced, and thickness or properties of the applied film may be uniform. As a result, shift in retardation can be reduced. Further, variation in gap distance between a discharge port of the application liquid and the substrate (aligned film) can be reduced, and the thickness of the applied film may be uniform. As a result, shift in retardation can be reduced. Further, variation in temperature of a drying furnace may be reduced. As a result, shift in retardation can be reduced.

### INDUSTRIAL APPLICABILITY

The liquid crystal panel of the present invention may suitably be used for various image display apparatuses (such as a liquid crystal display apparatus and a self-luminous display apparatus).

1. A method of producing a liquid crystal panel including a first optical compensation layer having refractive index profile of nx>ny=nz and a polarizer on each side of a liquid crystal cell in the order given, in which an angle formed between an absorption axis of the polarizer (A) and a slow axis of the first optical compensation layer (B) on one side of the liquid crystal cell is +α°, an angle formed between an absorption axis of the polarizer (A′) and a slow axis of the first compensation layer (B′) on another side of the liquid crystal cell is −α°, and 0<α<90, the method comprising the steps of:
subjecting a surface of a continuous substrate formed of single original sheet to alignment treatment at +α° or −α° with respect to a longitudinal direction of the substrate and then successively subjecting the resultant to alignment treatment at an angle of an opposite sign;
forming the first optical compensation layer (B) on the surface subjected to the +α° alignment treatment and forming the first optical compensation layer (B′) on the surface subjected to the −α° alignment treatment; and
attaching continuously a surface opposite to the surface of the substrate subjected to the alignment treatment and the continuous polarizer having an absorption axis in a longitudinal direction while arranging respective longitudinal directions in the same direction.

2. A method of producing a liquid crystal panel including a first optical compensation layer having refractive index profile of nx>ny=nz and a polarizer on each side of a liquid crystal cell in the order given, in which an angle formed between an absorption axis of the polarizer (A) and a slow axis of the first optical compensation layer (B) on one side of the liquid crystal cell is +α°, an angle formed between an absorption axis of the polarizer (A′) and a slow axis of the first compensation layer (B′) on another side of the liquid crystal cell is −α°, and 0<α<90, the method comprising the steps of:
subjecting a surface of a continuous substrate formed of single original sheet to alignment treatment at +α° or −α° with respect to a longitudinal direction of the substrate and then successively subjecting the resultant to alignment treatment at an angle of an opposite sign;
forming the first optical compensation layer (B) on the surface subjected to the +α° alignment treatment and forming the first optical compensation layer (B′) on the surface subjected to the −α° alignment treatment;
transferring the first optical compensation layers (B) and (B′) formed on the substrate to a surface of a transparent protective film and peeling the substrate; and
attaching continuously a surface opposite to the first optical compensation layers (B) and (B′) of the transparent protective film and the continuous polarizer having an absorption axis in a longitudinal direction while arranging respective longitudinal directions in the same direction.

3. A method of producing a liquid crystal panel according to claim 2, wherein the substrate formed of single original sheet is formed of single original sheet having a total length of 500 to 10,000 m.

4. A method of producing a liquid crystal panel according to claim 1, wherein the step of forming the first optical compensation layers (B) and (B′) comprises: a step of applying an application liquid containing a liquid crystal material; and a step of aligning the applied liquid crystal material through treatment at a temperature where the liquid crystal material exhibits a liquid crystal phase.

5. A method of producing a liquid crystal panel according to claim 4, wherein the first optical compensation layers (B) and (B′) are each formed by using an application liquid of the same lot.

6. A method of producing a liquid crystal panel according to claim 4, wherein: the liquid crystal material comprises a polymerizable monomer and/or a crosslinking monomer; and the step of aligning the liquid crystal material further comprises a step of conducting polymerization treatment and/or crosslinking treatment.

7. A method of producing a liquid crystal panel according to claim 6, wherein the polymerization treatment and/or the crosslinking treatment is conducted through at least one of heating, photoirradiation, and UV irradiation.

8. A method of producing a liquid crystal panel according to claim 1, wherein the liquid crystal panel comprises a second optical compensation layer (C) having refractive index profile of nx>ny>nz between the liquid crystal cell and the first optical compensation layer (B), and a second optical compensation layer (C′) having reflective index profile of nx>ny>nz between the liquid crystal cell and the first optical compensation layer (B′).

9. A method of producing a liquid crystal panel according to claim 8, wherein an angle formed between the absorption axis of the polarizer (A) and a slow axis of the second optical compensation layer (C) is +β°, an angle formed between the absorption axis of the polarizer (A′) and a slow axis of the second optical compensation layer (C′) is +β°, and the angle β is 85 to 95.

10. A method of producing a liquid crystal panel according to claim 1, wherein the first optical compensation layers (B) and (B′) are each a λ/2 plate.

11. A method of producing a liquid crystal panel according to claim 8, wherein the second optical compensation layers (C) and (C′) are each a λ/4 plate.

12. A liquid crystal panel, which is obtained by the method of producing a liquid crystal panel according to claim 1.

13. An image display apparatus, which comprises the liquid crystal panel according to claim 12.
